(19) United States
(12) Patent Application Publication
(10) Pub. No.: US 2023/0340300 A1
(43) Pub. Date: Oct. 26, 2023

(54) DECORATIVE MATERIAL, DECORATIVE PANEL, ELECTRONIC DEVICE, AND MANUFACTURING METHOD OF DECORATIVE MATERIAL

(71) Applicant: FUJIFILM CORPORATION, Tokyo (JP)

(72) Inventors: Akihiro ISHII, Kanagawa (JP); Yuichi HAYATA, Kanagawa (JP)

(21) Appl. No.: 18/346,791

(22) Filed: Jul. 4, 2023

Related U.S. Application Data
(63) Continuation of application No. PCT/JP2022/008336, filed on Feb. 28, 2022.

(30) Foreign Application Priority Data
Mar. 18, 2021 (JP) 2021-045075

(51) Int. Cl. C09J 7/29; C09J 7/38; C09K 19/58; C09K 19/38

(52) U.S. Cl. CPC C09J 7/29; C09J 7/38; C09K 19/588; C09K 19/3852; C09J 2301/302; C09J 2433/006

(57) ABSTRACT

Provided are a decorative material including a pressure sensitive adhesive layer and a cholesteric liquid crystal layer in contact with the pressure sensitive adhesive layer, in which, in the cholesteric liquid crystal layer, a content of a compound having a molecular weight of 10,000 or less per unit volume of the cholesteric liquid crystal layer is less than 44 mg/cm³; and applications thereof.

### CROSS-REFERENCE TO RELATED APPLICATIONS

This application is a continuation application of International Application No. PCT/JP2022/008336, filed Feb. 28, 2022, the disclosure of which is incorporated herein by reference in its entirety. Further, this application claims priority from Japanese Patent Application No. 2021-045075, filed Mar. 18, 2021, the disclosure of which is incorporated herein by reference in its entirety.

### BACKGROUND OF THE INVENTION

### 1. Field of the Invention

The present disclosure relates to a decorative material, a decorative panel, an electronic device, and a manufacturing method of a decorative material.

### 2. Description of the Related Art

It has been known that a cholesteric liquid crystalline phase is formed by helically arranging a plurality of liquid crystal compounds. A layer including the cholesteric liquid crystalline phase (hereinafter, also referred to as “cholesteric liquid crystal layer”) has been applied to various applications by utilizing optical characteristics of the cholesteric liquid crystalline phase. For example, the following techniques have been known as techniques related to a decorative material.

For example, WO2017/018468A discloses a cholesteric resin laminate including a base material, an interlayer, and a cholesteric resin layer in this order.

For example, WO2020/122245A discloses a decorative film for molding including a cured liquid crystal layer, which is formed by curing a liquid crystal layer containing a cholesteric liquid crystal compound and a photoisomerizable compound, on a base material, in which the cured liquid crystal layer has a plurality of regions where photoisomerizable proportions of the photoisomerizable compounds are different from each other.

For example, JP2017-205988A discloses a decorative sheet including a patterned cholesteric liquid crystal reflective layer.

### SUMMARY OF THE INVENTION

In a manufacturing process of the decorative material, the cholesteric liquid crystal layer may be cured in order to maintain an alignment of the liquid crystal compound in the cholesteric liquid crystalline phase. The curing of the cholesteric liquid crystal layer is performed, for example, by polymerization of a polymerizable compound (that is, a monomer) used as a raw material of the cholesteric liquid crystal layer. However, in spite of the curing of the cholesteric liquid crystal layer, for example, a tint of the decorative material may change in a thermal environment. Furthermore, in the study on stretchability of the decorative material, it has been clarified that, in a case where a crosslinking density of the cholesteric liquid crystal layer is lowered, the tint of the decorative material is likely to change in the thermal environment. The term “tint of the decorative material” includes color tone, chroma saturation, and lightness of the decorative material, which are visually perceived by the observer.

An object of an embodiment of the present disclosure is to provide a decorative material in which a change in tint is small in a thermal environment. An object of another embodiment of the present disclosure is to provide a manufacturing method of a decorative material in which a change in tint is small in a thermal environment.

The present disclosure includes the following aspects.
<1> A decorative material comprising:
a pressure sensitive adhesive layer; and
a cholesteric liquid crystal layer in contact with the pressure sensitive adhesive layer,
in which, in the cholesteric liquid crystal layer, a content of a compound having a molecular weight of 10,000 or less per unit volume of the cholesteric liquid crystal layer is less than 44 mg/cm³.
<2> The decorative material according to <1>,
in which a breaking elongation of the cholesteric liquid crystal layer is 20% or more.
<3> The decorative material according to <1> or <2>, further comprising:
a peelable base material,
in which the decorative material has a structure in which the peelable base material, the cholesteric liquid crystal layer, and the pressure sensitive adhesive layer are arranged in this order.
<4> The decorative material according to any one of <1> to <3>, further comprising:
a base material.
<5> The decorative material according to <4>,
in which the base material has an uneven structure.
<6> The decorative material according to any one of <1> to <5>,
in which reflection band central wavelengths of visible light, which are measured in at least two regions, are different from each other.
<7> The decorative material according to any one of <1> to <6>,
in which an absolute value of a difference between a reflection band central wavelength of visible light, which is measured before a heating test at 80° C. for 240 hours, and a reflection band central wavelength of visible light, which is measured after the heating test at 80° C. for 240 hours, is 0 nm to 20 nm.
<8> A decorative panel comprising:
a molded product of the decorative material according to any one of <1> to <7>.
<9> An electronic device comprising:
the decorative panel according to <8>.
<10> A manufacturing method of a decorative material, comprising, in the following order:
preparing a composition which contains a liquid crystal compound having a polymerizable group, a photoisomerizable chiral agent having a polymerizable group, and a photopolymerization initiator;
applying the composition onto a peelable base material;
curing the composition with light to form a cholesteric liquid crystal layer; and
forming a pressure sensitive adhesive layer on the cholesteric liquid crystal layer,
in which the photoisomerizable chiral agent includes a photoisomerizable chiral agent having two polymerizable groups, and
a proportion of a total amount of a compound having two polymerizable groups in the composition is 4% by mass to 20% by mass with respect to a total amount of solid contents of the composition.
<11> The manufacturing method of a decorative material according to <10>,
in which the photoisomerizable chiral agent is a compound represented by Formula (C1).

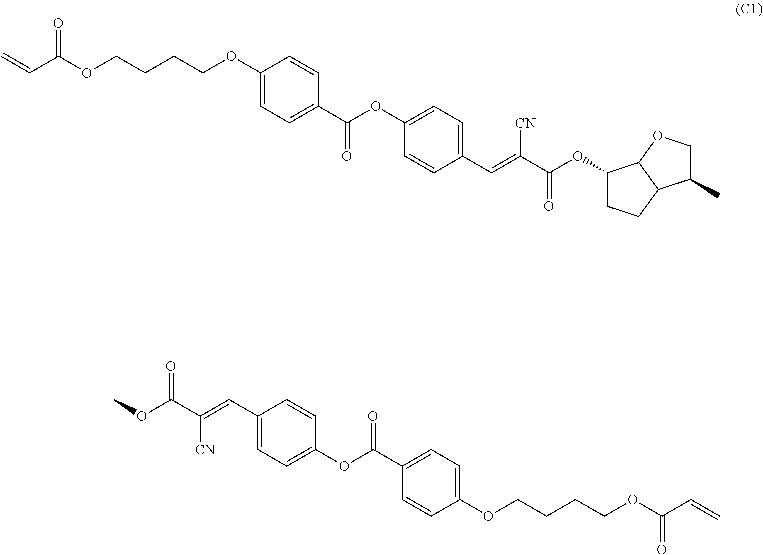

<12> The manufacturing method of a decorative material according to <10> or <11>, further comprising:
before the curing of the composition, irradiating the composition with light through a photo mask,
in which transmittances measured in at least two regions of the photo mask are different from each other.
<13> A manufacturing method of a decorative material, comprising:
preparing, by the manufacturing method of a decorative material according to any one of <10> to <12>, a laminate which includes a pressure sensitive adhesive layer and a cholesteric liquid crystal layer in contact with the pressure sensitive adhesive layer; and
bonding the laminate with a base material having an uneven structure.

According to an embodiment of the present disclosure, there is provided a decorative material in which a change in tint is small in a thermal environment. According to another embodiment of the present disclosure, there is provided a manufacturing method of a decorative material in which a change in tint is small in a thermal environment.

### BRIEF DESCRIPTION OF THE DRAWINGS

FIG. 1 is a schematic plan view showing an example of a mask for patterning, used for photoisomerization.

### DESCRIPTION OF THE PREFERRED EMBODIMENTS

Hereinafter, embodiments of the present disclosure will be described in detail. The present disclosure is not limited to the following embodiments. The following embodiments may be modified as appropriate within the scope of the purposes of the present disclosure.

The numerical range indicated by using “to” in the present disclosure indicates a range including numerical values described before and after “to” as a lower limit value and an upper limit value, respectively. Regarding numerical ranges which are described stepwise in the present disclosure, an upper limit value or a lower limit value described in a numerical range may be replaced with an upper limit value or a lower limit value of another stepwise numerical range. In addition, in the numerical ranges described in the present disclosure, an upper limit value and a lower limit value described in a numerical range may be replaced with values shown in Examples.

In the present disclosure, in a case where a plurality of substances corresponding to each component in a composition is present, the amount of each component in the composition means the total amount of the plurality of substances present in the composition, unless otherwise specified.

In the present disclosure, a term “step” denotes not only an individual step but also a step which is not clearly distinguishable from another step as long as an effect expected from the step can be achieved.

In the present disclosure, “% by mass” has the same definition as that for “% by weight”, and “part by mass” has the same definition as that for “part by weight”.

In the present disclosure, “(meth)acrylate” includes acrylate and methacrylate.

In the present disclosure, “(meth)acrylic” includes acrylic and methacrylic.

In the present disclosure, “solid content” means a component other than a solvent. A liquid component which does not correspond to the solvent is regarded as the solid content.

In the present disclosure, a group (atomic group) to which a term “substituted” or “unsubstituted” is not added includes a group having a substituent and a group not having a substituent. For example, “alkyl group” includes an alkyl group having a substituent and an alkyl group not having a substituent.

In the present disclosure, a combination of two or more preferred aspects is a more preferred aspect.

The weight-average molecular weight (Mw) and the number-average molecular weight (Mn) in the present disclosure are molecular weights in terms of polystyrene used as a standard substance, which are detected by using a solvent tetrahydrofuran (THF), a differential refractometer, and a gel permeation chromatography (GPC) analysis apparatus using TSKgel GMHxL, TSKgel G4000HxL, and TSKgel G2000HxL (all product names manufactured by Tosoh Corporation) as columns, unless otherwise specified.

Unless otherwise specified, transmittance in the present disclosure is measured using a spectrophotometer (for example, spectrophotometer UV-3100PC manufactured by Shimadzu Corporation).

<Decorative Material>

The decorative material according to the embodiment of the present disclosure includes a pressure sensitive adhesive layer and a cholesteric liquid crystal layer in contact with the pressure sensitive adhesive layer, in which, in the cholesteric liquid crystal layer, a content of a compound having a molecular weight of 10,000 or less per unit volume of the cholesteric liquid crystal layer is less than 44 mg/cm³. According to the above-described embodiment, there is provided a decorative material in which a change in tint is small in a thermal environment.

In the present disclosure, the reason for providing the decorative material in which the change in tint is small in a thermal environment is presumed as follows. The cholesteric liquid crystal layer includes a cholesteric liquid crystalline phase which is a kind of liquid crystal form. An alignment state of the liquid crystal compound in the cholesteric liquid crystalline phase, particularly, a helical structure formed by the liquid crystal compound affects, for example, a wavelength and intensity of light reflected by the cholesteric liquid crystal layer, and greatly influences the tint of the decorative material. In contrast to the decorative material in the related art, in the decorative material according to the embodiment of the present disclosure, the upper limit of a content of a low-molecular-weight compound in the cholesteric liquid crystal layer is restricted. Specifically, in the cholesteric liquid crystal layer, the content of the compound having a molecular weight of 10,000 or less per unit volume of the cholesteric liquid crystal layer is less than 44 mg/cm³. In a case where the upper limit of the content of the low-molecular-weight compound in the cholesteric liquid crystal layer is restricted as described above, it is considered that, even in a case where the decorative material is exposed to a thermal environment, migration of the low-molecular-weight compound from the cholesteric liquid crystal layer to other layers (for example, the pressure sensitive adhesive layer) is suppressed, and a change in helical structure (particularly, a pitch of the helical structure) is suppressed. Therefore, according to the embodiment of the present disclosure, there is provided a decorative material in which a change in tint is small in a thermal environment.

(Pressure Sensitive Adhesive Layer)

The decorative material according to the embodiment of the present disclosure includes a pressure sensitive adhesive layer. For example, the pressure sensitive adhesive layer can improve adhesiveness between layers in the decorative material. For example, the pressure sensitive adhesive layer can easily attach the decorative material to other members. The pressure sensitive adhesive layer is preferably a pressure sensitive adhesive layer which exhibits viscoelasticity at normal temperature (for example, 25° C.).

Examples of a component of the pressure sensitive adhesive layer include a pressure sensitive adhesive and an adhesive. Examples of the pressure sensitive adhesive include an acrylic pressure sensitive adhesive, a rubber-based pressure sensitive adhesive, and a silicone-based pressure sensitive adhesive. Examples of the pressure sensitive adhesive also include acrylic pressure sensitive adhesives, ultraviolet (UV) curable pressure sensitive adhesives, and silicone-based pressure sensitive adhesives described in “Chapters 2 of “Characterization evaluation of release paper, release film, and adhesive tape, and control technique thereof”, 2004, Information Mechanism”. The “acrylic pressure sensitive adhesive” means a pressure sensitive adhesive including a polymer of a (meth)acrylic monomer. In a case where the pressure sensitive adhesive layer contains a pressure sensitive adhesive, the pressure sensitive adhesive layer may further contain a viscosity imparting agent.

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

From the viewpoint of pressure sensitive strength and handleability, a thickness of the pressure sensitive adhesive layer is preferably 5 μm to 200 μm.

The pressure sensitive adhesive layer is formed of, for example, a composition containing at least one selected from the group consisting of a pressure sensitive adhesive and an adhesive. The pressure sensitive adhesive layer may be formed from, for example, a sheet-like pressure sensitive adhesive or an adhesive. Examples a commercially available product of the sheet-like pressure sensitive adhesive include a base material-less double sided tape G25 (NEION Film Coatings Corp.).

(Cholesteric Liquid Crystal Layer)

The decorative material according to the embodiment of the present disclosure includes a cholesteric liquid crystal layer in contact with the pressure sensitive adhesive layer. In a case where the cholesteric liquid crystal layer is in contact with the pressure sensitive adhesive layer, the pressure sensitive adhesive layer functions as a cushion, and followability of the cholesteric liquid crystal layer to an uneven shape can be improved.

The cholesteric liquid crystal layer is a layer including a cholesteric liquid crystalline phase. The cholesteric liquid crystalline phase is confirmed by a known unit (for example, a polarization microscope and a scanning electron microscope). The alignment state of the liquid crystal compound in the cholesteric liquid crystalline phase may be an alignment state which reflects dextrorotatory circularly polarized light, an alignment state which reflects levorotatory circularly polarized light, or an alignment state which reflects both dextrorotatory circularly polarized light and levorotatory circularly polarized light. The alignment state of the liquid crystal compound in the cholesteric liquid crystalline phase may be fixed. The alignment state of the liquid crystal compound is fixed, for example, by polymerization or crosslinking of the liquid crystal compound. Liquid crystallinity of the liquid crystal compound may be lost in a part or all of the liquid crystal compounds in which the alignment state is fixed.

The cholesteric liquid crystal layer contributes to design of the decorative material. For example, a degree of change in color of the decorative material according to the color of the decorative material and the observation angle is adjusted by the pitch of the helical structure in the cholesteric liquid crystalline phase, refractive index of the cholesteric liquid crystal layer, and a thickness of the cholesteric liquid crystal layer. The pitch of the helical structure may be adjusted by an addition amount of a chiral agent. A relationship between the helical structure and the chiral agent is described in, for example, “Fuji Film Research & Development, No. 50 (2005), pp. 60 to 63”. In addition, the pitch of the helical structure may be adjusted depending on conditions such as a temperature, an illuminance, and an irradiation time in fixing the cholesteric liquid crystalline phase.

In the cholesteric liquid crystal layer, the content of the compound having a molecular weight of 10,000 or less per unit volume of the cholesteric liquid crystal layer (hereinafter, may be referred to as “content of the low-molecular-weight compound”) is less than 44 mg/cm³. In a case where the content of the low-molecular-weight compound is less than 44 mg/cm³, the change in tint of the decorative material due to the migration of the low-molecular-weight compound is suppressed in the thermal environment. The content of the low-molecular-weight compound is preferably less than 35 mg/cm³, more preferably less than 20 mg/cm³, and still more preferably less than 10 mg/cm³. Examples of the low-molecular-weight compound include a monomer, an oligomer, a polymerization initiator, and a surfactant. However, as long as the molecular weight is 10,000 or less, the type of the low-molecular-weight compound is not limited to the above-described specific examples. The content of the low-molecular-weight compound is adjusted, for example, by components of a composition forming the cholesteric liquid crystal layer, and curing conditions. For example, optimization of the type of the polymerizable compound (for example, the type and number of polymerizable groups), the addition amount of the polymerizable compound, and the addition amount of a non-polymerizable compound can promote the curing reaction and reduce the content of the low-molecular-weight compound. For example, in curing with light, the optimization of the illuminance, the irradiation amount, and the temperature can promote the curing reaction and reduce the content of the low-molecular-weight compound. Preferred aspects of the components of the composition and curing conditions will be described later.

The low-molecular-weight compound (that is, the compound having a molecular weight of 10,000 or less) is identified by a known analytical method (for example, nuclear magnetic resonance and mass spectrometry). Quantitative analysis of the low-molecular-weight compound is carried out by liquid chromatography in comparison with a standard product. Specific conditions for the liquid chromatography are shown below. A measurement sample is prepared by immersing a 1 cm² cholesteric liquid crystal layer in tetrahydrofuran (THF, 1 mL), allowing it to stand overnight, and then recovering THF. The content of the low-molecular-weight compound is determined in consideration of the result of the quantitative analysis and a thickness of the cholesteric liquid crystal layer to be collected.
Device: HP1260 manufactured by Agilent Technologies, Inc.
Column: Kinetex EVO C18 manufactured by Phenomenex Inc.; 100 Å, 2.6 μm, 2.1 mm×100 mm
Mobile phase A: 10 mmol/L ammonium acetate aqueous solution
Mobile phase B: acetonitrile
Flow rate: 0.3 mL/min
Column Temperature: 40° C.
Injection amount: 2 μL
Detection: photodiode array (PDA)
Detection channel: 265 nm, 280 nm, and 315 nm

A breaking elongation of the cholesteric liquid crystal layer is preferably 20% or more, more preferably 25% or more, and still more preferably 30% or more. In a case where the breaking elongation of the cholesteric liquid crystal layer is 20% or more, followability of the cholesteric liquid crystal layer to a shape of an object to be decorated and moldability (particularly, three-dimensional moldability) of the decorative material are improved. The breaking elongation of the cholesteric liquid crystal layer is preferably 500% or less, more preferably 400% or less, and still more preferably 300% or less. In a case where the breaking elongation of the cholesteric liquid crystal layer is 500% or less, strength of the cholesteric liquid crystal layer is improved. The breaking elongation of the cholesteric liquid crystal layer is adjusted, for example, by a crosslinking density of the cholesteric liquid crystal layer. In a case where the crosslinking density of the cholesteric liquid crystal layer decreases, the breaking elongation of the cholesteric liquid crystal layer tends to increase. The crosslinking density of the cholesteric liquid crystal layer is adjusted, for example, by components of a composition forming the cholesteric liquid crystal layer, and curing conditions. For example, optimization of the type of the polymerizable compound (for example, the type and number of polymerizable groups) and the addition amount of the polymerizable compound can decrease the crosslinking density of the cholesteric liquid crystal layer and increase the breaking elongation of the cholesteric liquid crystal layer. The components of the composition for forming the cholesteric liquid crystal layer and the curing conditions of the cholesteric liquid crystal layer will be described later.

It is confirmed by the following method that the breaking elongation of the cholesteric liquid crystal layer is 20% or more. Specifically, in a case where the breaking elongation of each layer excluding the pressure sensitive adhesive layer and the cholesteric liquid crystal layer is 20% or more, the following method (1) is adopted, and in a case where the breaking elongation of layers excluding the pressure sensitive adhesive layer and the cholesteric liquid crystal layer is less than 20%, the following method (2) or (3) is adopted. Regarding the methods (2) and (3), in a case where the decorative material includes a base material having an uneven structure (however, among base materials having an uneven structure, the base material is limited to a base material in which, in one period of the uneven structure, a proportion of “length of a path measured, along a surface of the uneven structure, from one local minimum portion to the next local minimum portion” with respect to “interval between two adjacent local minimum portions” is 120% or more), the method (2) is adopted, and in a case where the decorative material does not include the base material having the specific uneven structure, the method (3) is adopted. The breaking elongation is measured by a method according to the method described in the section of “Stretchability” in Examples later. Matters relating to the base material having an uneven structure will be described in the section of “Base material” later.
(1) in a case where the breaking elongation of the decorative material is 20% or more, the breaking elongation of the cholesteric liquid crystal layer is considered to be 20% or more.
(2) in a cross-sectional view along a thickness direction of the decorative material, in a case where a shape of the cholesteric liquid crystal layer corresponds to a shape of the base material having an uneven structure, the breaking elongation of the cholesteric liquid crystal layer is considered to be 20% or more; the “shape of the liquid crystal layer corresponds to a shape of the base material having an uneven structure” means that the liquid crystal layer is disposed so as to follow the shape of the surface (specifically, the shape defining the uneven structure) of the base material having an uneven structure.
(3) by bonding the decorative material with the base material having an uneven structure, a laminate including the pressure sensitive adhesive layer, the cholesteric liquid crystal layer, and the base material having an uneven structure in this order is prepared; in a cross-sectional view along a thickness direction of the obtained laminate, in a case where a shape of the cholesteric liquid crystal layer corresponds to an uneven shape of the base material, the breaking elongation of the cholesteric liquid crystal layer is considered to be 20% or more; however, in the method (3), a height (H) of a convex portion in the uneven structure is set to 10 μm, and a width (W) of the convex portion is set to 30 μm.

The cholesteric liquid crystal layer preferably has selective reflectivity. For example, the cholesteric liquid crystal layer preferably has reflectivity at least one of 380 nm to 1,200 nm (preferably 380 nm to 780 nm). A wavelength of light reflected by the cholesteric liquid crystal layer is measured using a spectrophotometer (for example, spectrophotometer UV-3100PC manufactured by Shimadzu Corporation).

From the viewpoint of suppressing change in reflectivity after molding, a thickness of the cholesteric liquid crystal layer is preferably less than 10 μm, more preferably 5 μm or less, more preferably 0.05 μm to 5 μm, and particularly preferably 0.1 μm to 4 μm.

The cholesteric liquid crystal layer is formed of, for example, a composition containing a liquid crystal compound (hereinafter, may be simply referred to as “composition”). The composition preferably contains a liquid crystal compound, a chiral agent, and a polymerization initiator, and more preferably contains a liquid crystal compound, a photoisomerizable chiral agent, and a photopolymerization initiator. The photoisomerizable chiral agent is a photoisomerizable compound which also acts as the chiral agent. The cholesteric liquid crystal layer is preferably a cured substance of the composition containing a liquid crystal compound. A curing method of the composition will be described in the section of “Manufacturing method of decorative material” later. Hereinafter, aspects of the composition will be specifically described. As a preferred aspect of the composition, an aspect of the composition described in the section of “Manufacturing method of decorative material” later may be adopted.

In the composition, a proportion of the total amount of a compound having two polymerizable groups with respect to the total amount of solid contents of the composition (that is, [Total amount of compound having two polymerizable groups]/[Total amount of solid contents of composition]) is preferably 4% by mass to 25% by mass. In a case where the above-described proportion is 4% by mass or more, reactivity is improved, and the content of the compound having a molecular weight of 10,000 or less per unit volume of the cholesteric liquid crystal layer (that is, the content of the low-molecular-weight compound) is reduced. In the composition, the proportion of the total amount of the compound having two polymerizable groups with respect to the total amount of solid contents of the composition is preferably 6% by mass or more, more preferably 8% by mass or more, and still more preferably 10% by mass or more. On the other hand, in a case where the above-described proportion is 25% by mass or less, an increase in crosslinking density of the cholesteric liquid crystal layer is suppressed, and the breaking elongation of the cholesteric liquid crystal layer is increased. In the composition, the proportion of the total amount of the compound having two polymerizable groups with respect to the total amount of solid contents of the composition is preferably 20% by mass or less, more preferably 15% by mass or less, still more preferably 10% by mass or less, and particularly preferably 5% by mass or less.

The composition contains a liquid crystal compound. The liquid crystal compound is a compound having liquid crystallinity. However, the liquid crystallinity of the liquid crystal compound may be lost in the cured substance of the composition.

The liquid crystal compound may be selected from known compounds having cholesteric liquid crystallinity. The type of the liquid crystal compound is roughly classified into, for example, a rod-like liquid crystal compound and a disk-like liquid crystal compound according to a chemical structure. Furthermore, the rod-like liquid crystal compound is roughly classified into a low-molecular-weight type and a high-molecular-weight type, and the disk-like liquid crystal compound is also roughly classified into a low-molecular-weight type and a high-molecular-weight type. The term “high-molecular-weight” used for the liquid crystal compound means a compound having a degree of polymerization of 100 or more (for example, Masao Doi; Polymer Physics-Phase Transition Dynamics, 1992, IWANAMI SHOTEN, PUBLISHERS, page 2). As the liquid crystal compound, a mixture of two or more kinds of the rod-like liquid crystal compounds, two or more kinds of the disk-like liquid crystal compounds, or the rod-like liquid crystal compound and the disk-like liquid crystal compound may be used.

As the liquid crystal compound, a mixture of two or more kinds of the rod-like liquid crystal compounds, two or more kinds of the disk-like liquid crystal compounds, or the rod-like liquid crystal compound and the disk-like liquid crystal compound may be used. Since changes in temperature and humidity can be reduced, as the liquid crystal compound, it is more preferable to use a rod-like liquid crystal compound or disk-like liquid crystal compound having a reactive group, and it is still more preferable that at least one of these liquid crystal compounds has two or more reactive groups in one liquid crystal molecule. In a case of a mixture of two or more liquid crystal compounds, it is preferable that at least one thereof has two or more reactive groups.

In addition, it is preferable to use a liquid crystal compound having two or more reactive groups having different crosslinking mechanisms. The crosslinking mechanism is not particularly limited such as condensation reaction, hydrogen bond, and polymerization, but in a case where two or more reactive groups are present, it is preferable that at least one of two or more crosslinking mechanisms used is polymerization, and it is more preferable to use two or more different polymerization reactions. In the crosslinking reaction in the above-described crosslinking, not only a vinyl group, a (meth)acryloyl group, an epoxy group, an oxetanyl group, or a vinyl ether group is used for polymerization, but also a hydroxy group, a carboxy group, an amino group, or the like can be used.

The compound having two or more reactive groups having different crosslinking mechanisms in the present disclosure is a compound which can be crosslinked stepwise using different crosslinking reaction steps, and in the crosslinking reaction step of each step, the reactive group corresponding to each crosslinking mechanism reacts as a functional group. For example, in a case of a polymer such as polyvinyl alcohol, which has a hydroxy group in the side chain, and a case where the hydroxy group of the side chain is crosslinked with an aldehyde or the like after a polymerization reaction to polymerize the polymer, the case means that two or more different crosslinking mechanisms are used. However, in the present disclosure, it is preferable that the case of the compound having two or more different reactive groups means a compound having two or more different reactive groups in a layer immediately before a timing of forming the layer on a support or the like, and means a compound capable of subsequently crosslinking the reactive groups stepwise.

The reactive group is preferably a polymerizable group. Examples of the polymerizable group include radically polymerizable group and cationically polymerizable group. Examples of a preferred polymerizable group include an acryloyl group and a methacryloyl group. It is particularly preferable to use a liquid crystal compound having two or more polymerizable groups.

The distinction of reaction conditions for stepwise crosslinking may be a distinction of temperature, a distinction of wavelength of light (irradiation ray), or a distinction of polymerization mechanism, but from the viewpoint the reaction can be easily separated, it is preferable to use a distinction of polymerization mechanism, and it is more preferable to control the reaction by the type of the polymerization initiator used.

As a combination of the polymerizable groups, a combination of a radically polymerizable group and a cationically polymerizable group is preferable. Among these, a combination in which the radically polymerizable group is a vinyl group or a (meth)acryloyl group and the above-described cationically polymerizable group is an epoxy group, an oxetanyl group, or a vinyl ether group is particularly preferable because the reactivity can be easily controlled.

From the viewpoint of reactivity and ease of fixing the pitch of the helical structure, the liquid crystal compound preferably has a radically polymerizable group.

Examples of the reactive group are shown below. Et represents an ethyl group and n-Pr represents an n-propyl group.

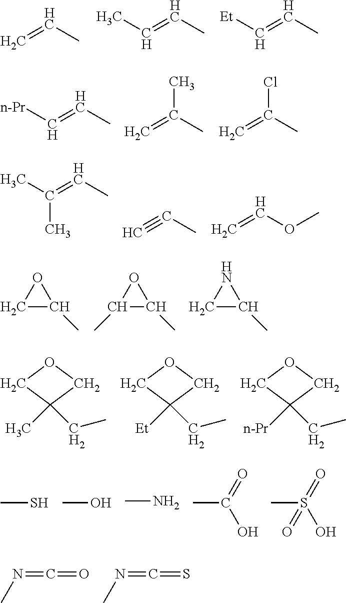

Preferred examples of the rod-like liquid crystal compound include azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles. In addition to the above-described low-molecular weight liquid crystal compounds, a high-molecular weight liquid crystal compound can also be used. The high-molecular weight liquid crystal compound is a polymer compound obtained by polymerizing a rod-like liquid crystal compound having a low-molecular weight reactive group. Examples of the rod-like liquid crystal compound include compounds described in JP2008-281989A, JP1999-513019A (JP-H11-513019A) (WO1997/00600A), or JP2006-526165A.

Specific examples of the rod-like liquid crystal compound are shown below, but the rod-like liquid crystal compound is not limited thereto. The compounds shown below can be synthesized by the method described in JP1999-513019A (JP-H11-513019A) (WO1997/00600A).

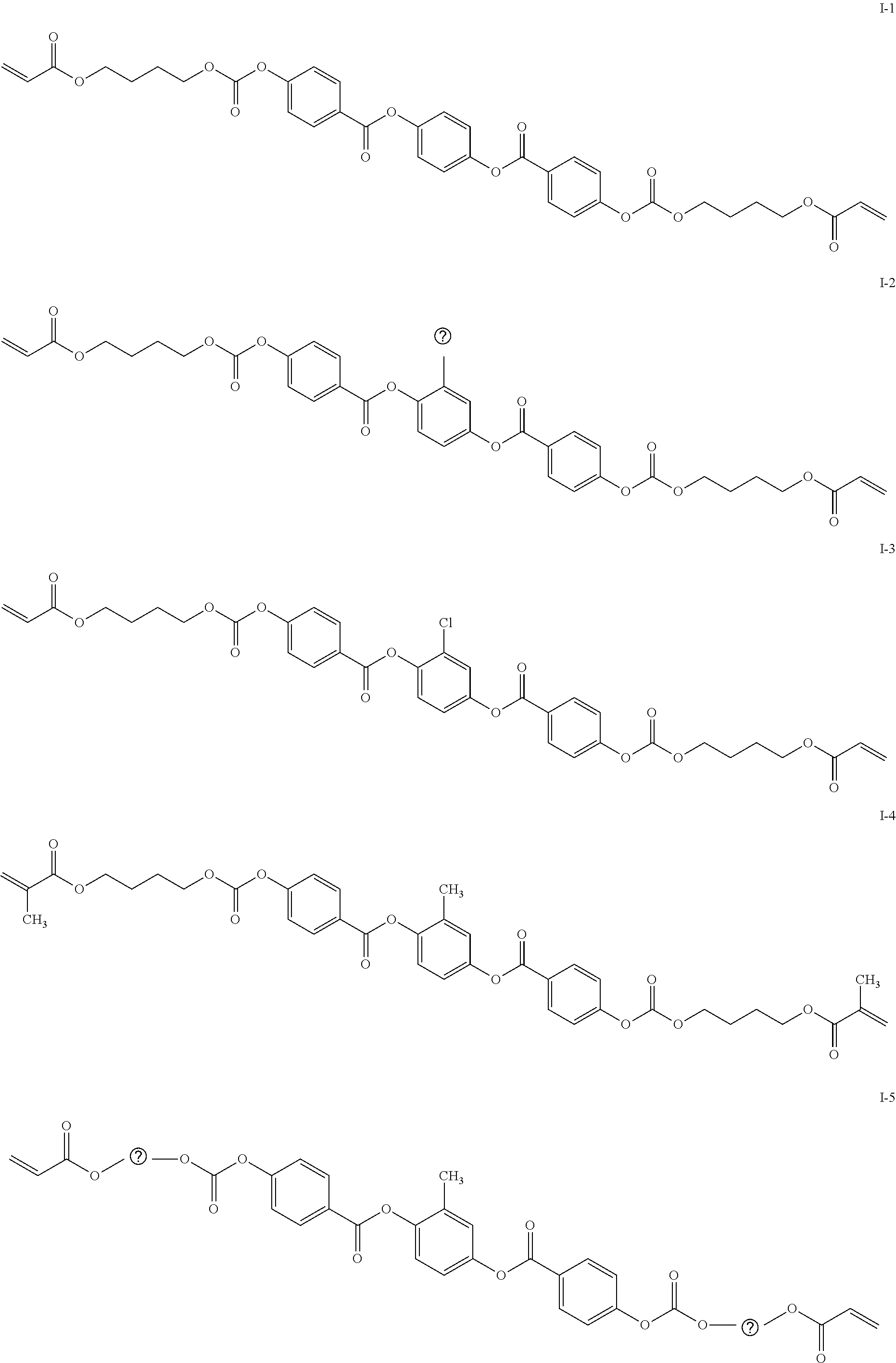

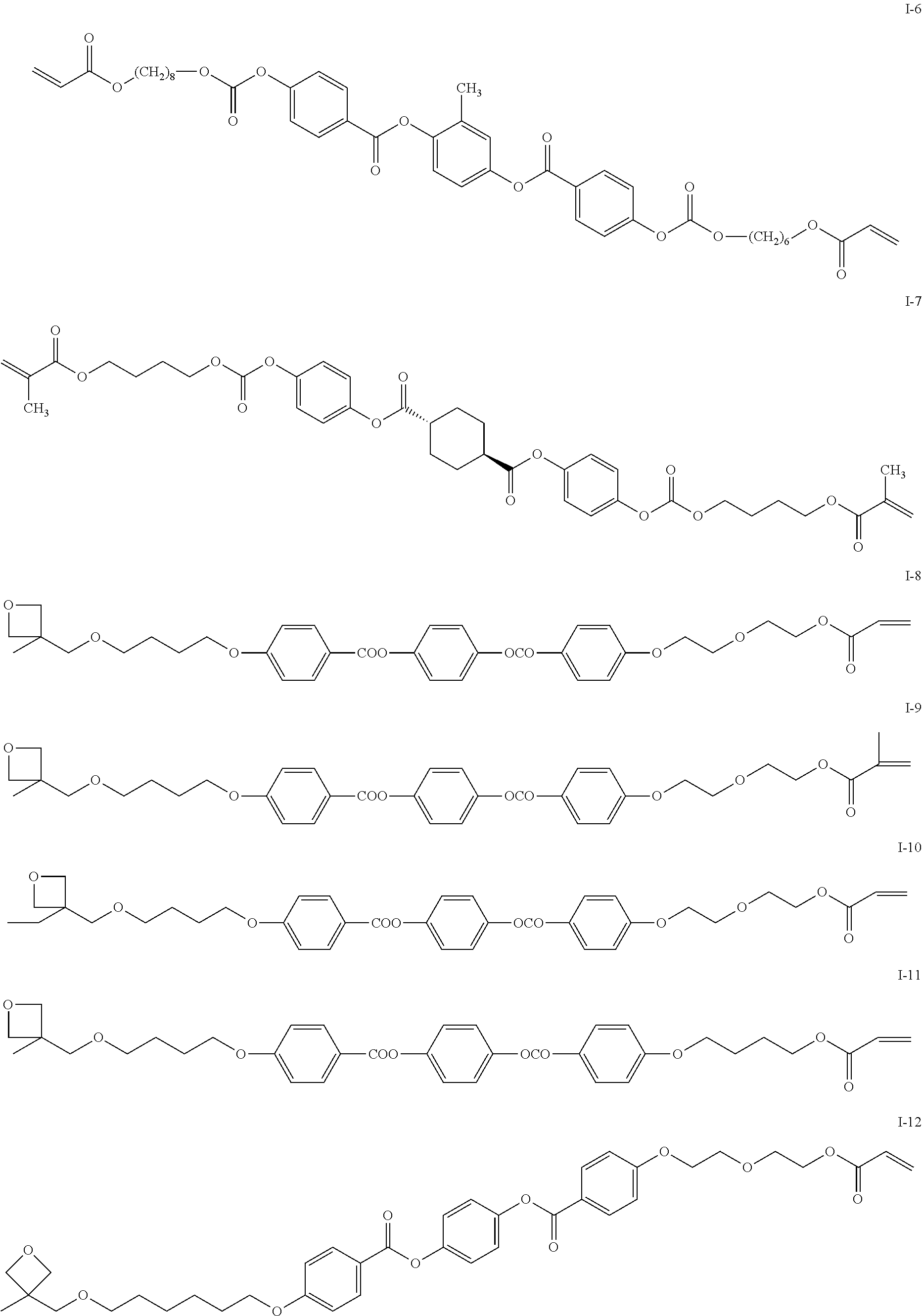

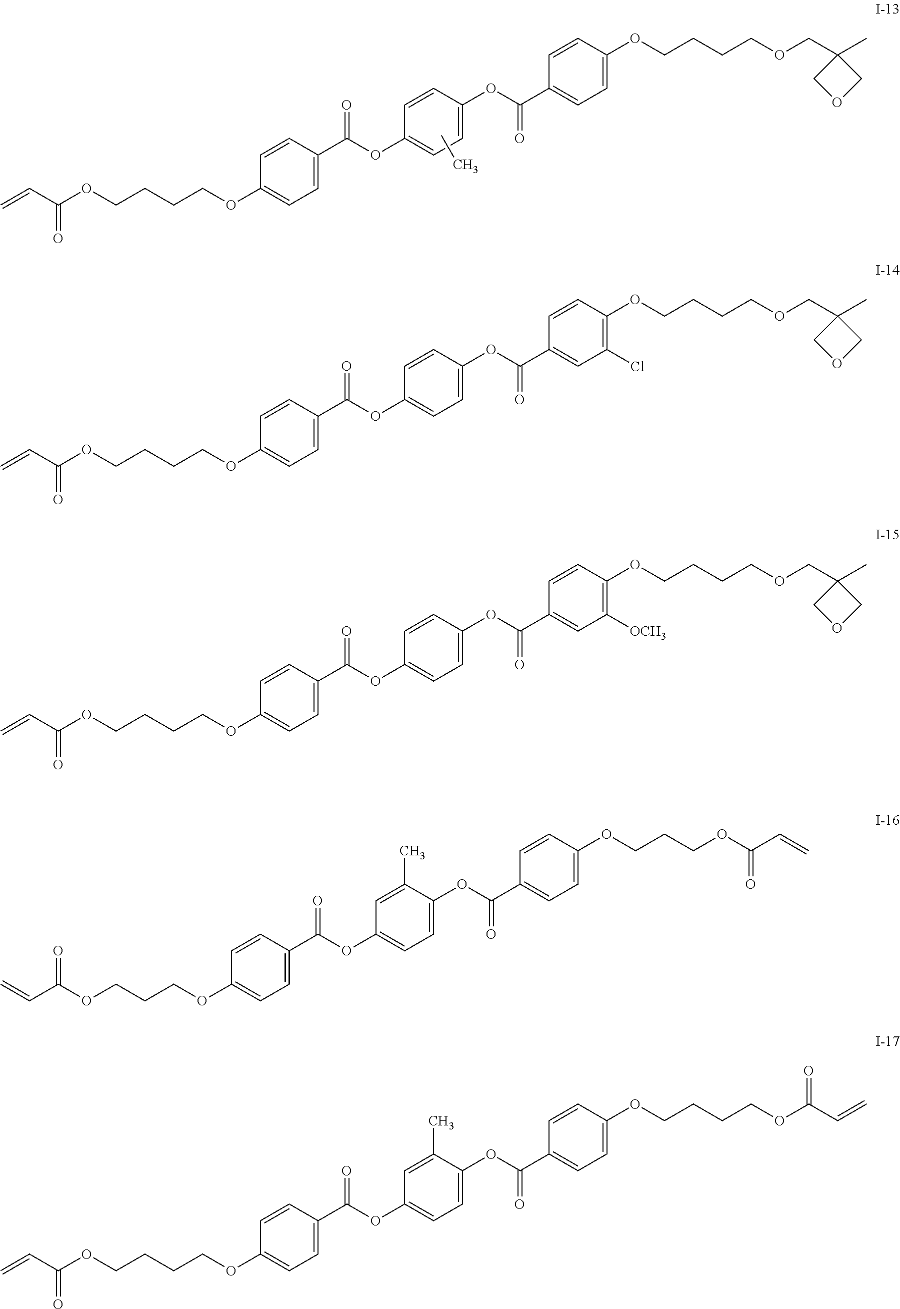

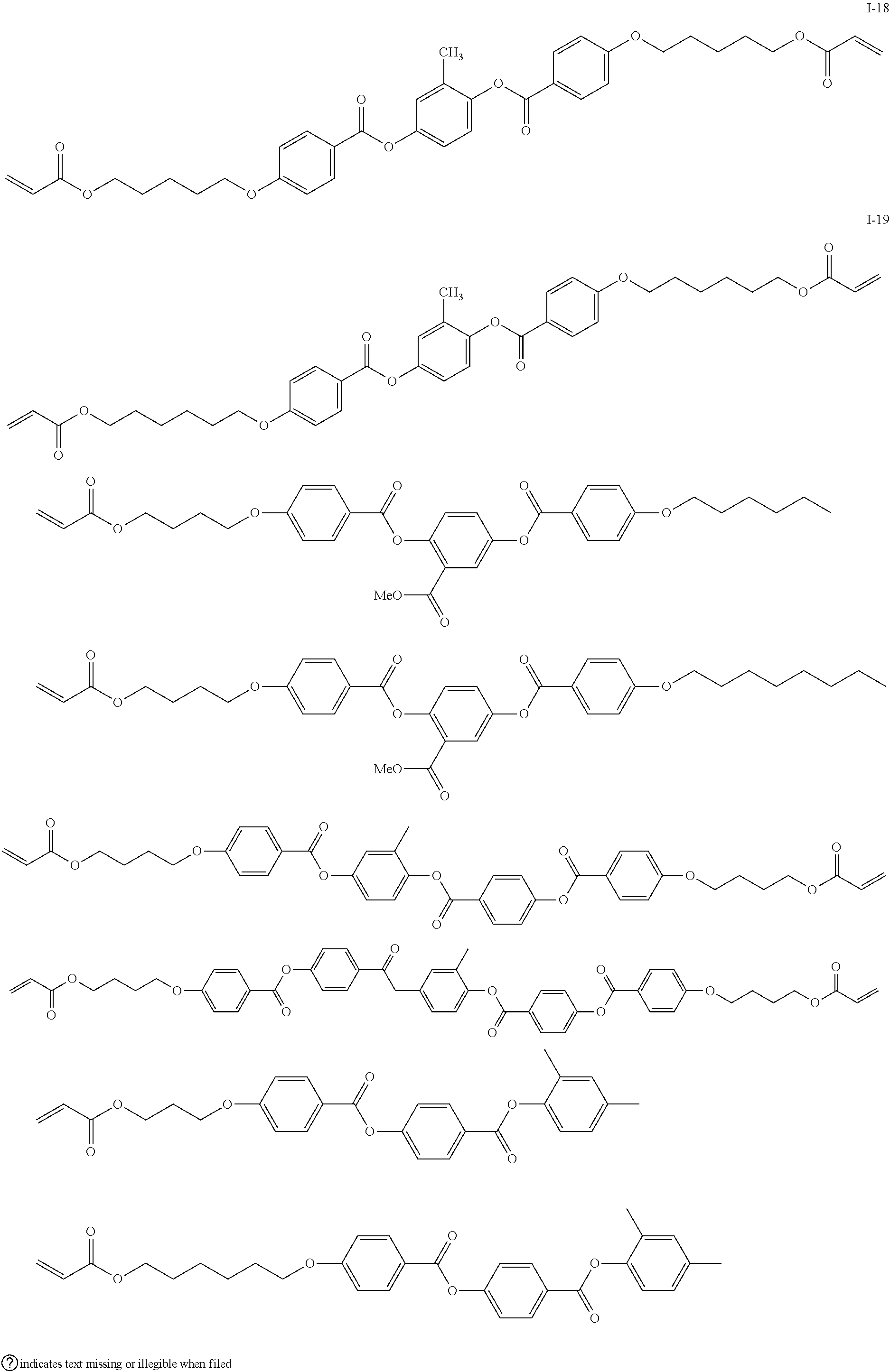

Examples of the disk-like liquid crystal compound include low-molecular-weight disk-like liquid crystal compounds such as a monomer, and polymerizable disk-like liquid crystal compounds.

Examples of the disk-like liquid crystal compound include benzene derivatives described in C. Destrade et. al.'s study report, “Mol. Cryst.”, vol. 71, page 111 (1981); truxene derivatives described in C. Destrade et. al.'s study report, “Mol. Cryst.”, vol. 122, page 141 (1985) and “Physics lett, A”, vol. 78, page 82 (1990); cyclohexane derivatives described in B. Kohne et. al.'s study report, “Angew. Chem.”, vol. 96, page 70 (1984); and azacrown-based or phenyl acetylene-based macrocycles described in J. M. Lehn et. al.'s study report, “J. Chem. Commun.”, page 1794 (1985) and J. Zhang et. al.'s study report, “J. Am. Chem. Soc.”, vol. 116, page 2655 (1994).

The disk-like liquid crystal compound includes a liquid crystal compound, generally called a disk-like liquid crystal, which has the above-described various structures as a disk-like mother nucleus at the center of the molecule, has a structure in which groups (L) such as a linear alkyl group, alkoxy group, and a substituted benzoyloxy group are radially substituted, and exhibits liquid crystallinity. In a case where such an aggregate of molecules is uniformly aligned, the aggregate exhibits negative uniaxiality, but the disk-like cholesteric compound is not limited to this description. Examples of the disk-like liquid crystal compound include compounds described in paragraphs 0061 to 0075 of JP2008-281989A.

In a case where a disk-like liquid crystal compound having a reactive group is used as the liquid crystal compound, in the cured cholesteric liquid crystal layer, the disk-like liquid crystal compound having a reactive group may be fixed in any alignment state of horizontal alignment, homeotropic alignment, tilt alignment, or twist alignment.

The cholesteric liquid crystal layer may contain one kind or two or more kinds of the liquid crystal compounds.

From the viewpoint of designability, a content of the liquid crystal compound is preferably 30% by mass to 99% by mass, more preferably 40% by mass to 99% by mass, still more preferably 60% by mass to 99% by mass, and particularly preferably 70% by mass to 98% by mass with respect to the total mass of solid contents of the composition.

The composition may contain a polymerizable monomer in order to promote crosslinking of the liquid crystal compound. For example, a monomer or oligomer having two or more ethylenically unsaturated bonds and addition-polymerizing by irradiation with light can be used as the polymerizable monomer. Examples of the monomer and the oligomer include compounds having at least one addition-polymerizable ethylenically unsaturated group in the molecule. Examples thereof include monofunctional acrylates or monofunctional methacrylates, such as polyethylene glycol mono(meth)acrylate, polypropylene glycol mono(meth)acrylate, and phenoxyethyl (meth)acrylate; polyethylene glycol di(meta)acrylate, polypropylene glycol di(meta)acrylate, trimethylol ethane triacrylate, trimethylol propane tri(meta)acrylate, trimethylol propane diacrylate, neopentyl glycol di(meta)acrylate, pentaerythritol tetra(meta)acrylate, pentaerythritol tri(meta)acrylate, dipentaerythritol hexa(meta)acrylate, dipentaerythritol penta(meta)acrylate, hexanediol di(meta)acrylate, trimethylol propane tri(acryloyloxypropyl)ether, tri(acryloyloxyethyl) isocyanurate, tri(acryloyloxyethyl) cyanurate, and glycerin tri(meth)acrylate; and polyfunctional acrylates or polyfunctional methacrylates, such as those obtained by adding ethylene oxide or propylene oxide to polyfunctional alcohols such as trimethylolpropane and glycerin and then being (meth)acrylated.

Furthermore, examples thereof include polyfunctional acrylates or methacrylates such as urethane acrylates described in JP1973-41708B (JP-S48-41708B), JP1975-006034B (JP-S50-6034B), and JP1976-37193A (JP-S51-37193A); polyester acrylates described in JP1973-64183B (JP-S48-64183B), JP1974-43191B (JP-S49-43191B), and JP1977-30490B (JP-S52-30490B); and epoxy acrylates which are reaction products of epoxy resin and (meth)acrylic acid.

Trimethylol propane tri(meta)acrylate, pentaerythritol tetra(meth)acrylate, dipentaerythritol hexa(meth)acrylate, or dipentaerythritol penta(meth)acrylate is preferable.

In addition, the “polymerizable compound B” described in JP1999-133600A (JP-H11-133600A) can also be exemplified as a suitable compound.

These monomers or oligomers may be used alone or in a mixture of two or more thereof.

In addition, a cationically polymerizable monomer can also be used. Examples thereof include epoxy compounds, vinyl ether compounds, and oxetane compounds, which are exemplified in JP1994-9714A (JP-H6-9714A), JP2001-31892A, JP2001-40068A, JP2001-55507A, JP2001-310938A, JP2001-310937A, and JP2001-220526A. Examples of the epoxy compound include the following aromatic epoxides, alicyclic epoxides, and aliphatic epoxides.

Examples of the aromatic epoxide include di or polyglycidyl ethers of bisphenol A or an alkylene oxide adduct of bisphenol A, di or polyglycidyl ethers of hydrogenated bisphenol A or an alkylene oxide adduct of hydrogenated bisphenol A, and novolak-type epoxy resin. Here, examples of the alkylene oxide include ethylene oxide and propylene oxide.

Examples of the alicyclic epoxide include cyclohexene oxide or cyclopentene oxide-containing compounds, which are obtained by epoxidizing a compound having at least one cycloalkane ring such as a cyclohexene ring and a cyclopentene ring with an appropriate oxidizing agent such as hydrogen peroxide and peroxy acid.

Preferred aliphatic epoxides include aliphatic polyhydric alcohols or di or polyglycidyl ethers of an alkylene oxide adduct of polyhydric alcohol, and typical examples thereof include diglycidyl ethers of alkylene glycol, such as diglycidyl ether of ethylene glycol, diglycidyl ether of propylene glycol, and diglycidyl ether of 1,6-hexanediol; polyglycidyl ethers of polyhydric alcohol, such as di or triglycidyl ether of glycerin or an alkylene oxide adduct of glycerin; and diglycidyl ethers of polyalkylene glycol, such as diglycidyl ether of polyethylene glycol or an alkylene oxide adduct of polyethylene glycol, and diglycidyl ether of polypropylene glycol or an alkylene oxide adduct of polypropylene glycol. Here, examples of the alkylene oxide include ethylene oxide and propylene oxide.

In addition, as the cationically polymerizable monomer, a monofunctional or bifunctional oxetane monomer can also be used. For example, 3-ethyl-3-hydroxymethyloxetane (such as product name OXT 101 manufactured by TOAGOSEI CO., LTD.), 1,4-bis[(3-ethyl-3-oxetanyl)methoxymethyl]benzene (such as OXT 121), 3-ethyl-3-(phenoxymethyl)oxetane (such as OXT 211), di(1-ethyl-3-oxetanyl)methyl ether (such as OXT 221), 3-ethyl-3-(2-ethylhexyloxymethyl)oxetane (such as OXT 212), or the like can be preferably used. In particular, compounds such as 3-ethyl-3-hydroxymethyloxetane, 3-ethyl-3-(phenoxymethyl)oxetane, di(1-ethyl-3-oxetanyl)methyl ether, and any known monofunctional or polyfunctional oxetane compound described in JP2001-220526A and JP2001-310937A can be used.

The composition preferably contains a chiral agent, and more preferably contains a photoisomerizable chiral agent. The chiral agent can induce a helical structure due to the liquid crystal compound. The photoisomerizable chiral agent preferably includes a photoisomerizable chiral agent having two polymerizable groups (hereinafter, referred to as “bifunctional photoisomerizable chiral agent” in this paragraph). The bifunctional photoisomerizable chiral agent can induce the helical structure due to the liquid crystal compound, and also promote the curing reaction and reduce the content of the low-molecular-weight compound in the cholesteric liquid crystal layer.

As the chiral agent, a known compound can be used, but a chiral agent having a cinnamoyl group is preferable. Examples of the chiral agent include compounds described in Liquid Crystal Device Handbook, Chapter 3 articles 4-3, TN, chiral agent for STN, page 199, Japan Society for the Promotion of Science No. 142 committee version, 1989, and JP2003-287623A, JP2002-302487A, JP2002-80478A, JP2002-80851A, JP2010-181852A, and JP2014-034581A.

The chiral agent preferably includes an asymmetric carbon atom, but an axially chiral compound or a planar chiral compound, which does not have the asymmetric carbon atom, can also be used as the chiral agent. Examples of the axially chiral compound or the planar chiral compound include binaphthyl, helicene, paracyclophane, and derivatives thereof.

The chiral agent may have a polymerizable group. In a case where both the chiral agent and the liquid crystal compound have a polymerizable group, by a polymerization reaction between the chiral agent (polymerizable chiral agent) having a polymerizable group and the liquid crystal compound (polymerizable liquid crystal compound) having a polymerizable group, a polymer having a constitutional unit derived from the polymerizable liquid crystal compound, and a constitutional unit derived from the chiral agent can be formed. In this aspect, the polymerizable group of the polymerizable chiral agent is preferably the same polymerizable group as the polymerizable group of the polymerizable liquid crystal compound. The polymerizable group of the chiral agent is preferably an ethylenically unsaturated group, an epoxy group, or an aziridinyl group and more preferably an ethylenically unsaturated group.

The chiral agent preferably includes at least one selected from the group consisting of an isosorbide derivative, an isomannide derivative, and a binaphthyl derivative. As the isosorbide derivative, a commercially available product such as LC-756 manufactured by BASF may be used.

The chiral agent may be a cholesteric liquid crystal compound.

The chiral agent preferably includes a photoisomerizable compound which also acts the chiral agent (that is, the photoisomerizable chiral agent), and more preferably includes a compound represented by Formula (CH1) described later.

The photoisomerizable compound may be a compound capable of photoisomerization, but from the viewpoint of suppressing change in reflectivity after molding and maintaining the isomerized structure, the photoisomerizable compound is preferably a compound in which a three-dimensional structure changes with exposure.

The isomerized structure of the photoisomerizable compound is not particularly limited, but from the viewpoint of suppressing change in reflectivity after molding, ease of photoisomerization, and maintaining the isomerized structure, it is preferable to be a structure in which a three-dimensional structure changes with exposure, it is more preferable to have a di or higher-substituted ethylenically unsaturated bond in which an EZ configuration is isomerized by exposure, and it is particularly preferable to have a di-substituted ethylenically unsaturated bond in which an EZ configuration is isomerized by exposure. The isomerization of the EZ configuration also includes cis-trans isomerization. The di-substituted ethylenically unsaturated bond is preferably an ethylenically unsaturated bond in which an aromatic group and an ester bond are substituted.

The photoisomerizable compound may have only one isomerized structure or may have two or more photoisomerized structures, but from the viewpoint of suppressing change in reflectivity after molding, ease of photoisomerization, and maintaining the isomerized structure, it is preferable to have two or more isomerized structures, it is more preferable to have two to four isomerized structures, and it is particularly preferable to have two isomerized structures.

The photoisomerizable compound which also acts as a chiral agent is preferably a chiral agent having a molar absorption coefficient of 30,000 or more at a wavelength of 313 nm.

Preferred examples of the photoisomerizable compound which also acts as the chiral agent include a compound represented by Formula (CH1). The compound represented by Formula (CH1) can change the alignment structure such as the helical pitch (twisting force and helical twist angle) of a cholesteric liquid crystalline phase according to the amount of light during irradiation with light. In addition, the compound represented by Formula (CH1) is a compound in which the EZ configuration in the two ethylenically unsaturated bonds can be isomerized by exposure.

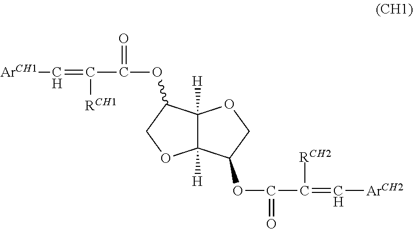

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group.

The aryl group of Ar^{CH1} and Ar^{CH2} in Formula (CH1) may have a substituent, and the aryl group thereof preferably has a total carbon number of 6 to 40, and more preferably has a total carbon number of 6 to 30. As the substituent, for example, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a hetero ring group is preferable, and a halogen atom, an alkyl group, an alkenyl group, an alkoxy group, a hydroxy group, an acyloxy group, an alkoxycarbonyl group, or an aryloxycarbonyl group is more preferable.

In Formula (CH1), it is preferable that R^{CH1} and R^{CH2} are each independently a hydrogen atom.

As Ar^{CH1} and Ar^{CH2}, an aryl group represented by Formula (CH2) or Formula (CH3) is preferable.

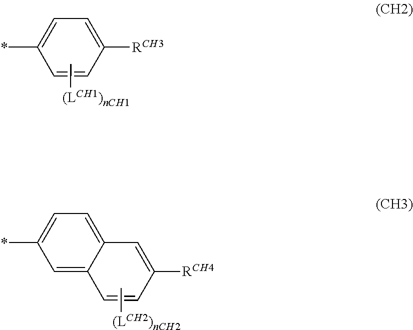

In Formula (CH2) and Formula (CH3), R^{CH3} and R^{CH4} each independently represent a hydrogen atom, a halogen atom, an alkyl group, an alkenyl group, an alkynyl group, an aryl group, a hetero ring group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with the ethylenically unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.

nCH1 in Formula (CH2) is preferably 0 or 1.

nCH2 in Formula (CH3) is preferably 0 or 1.

The heteroaromatic ring group of Ar^{CH1} and Ar^{CH2} in Formula (CH1) may have a substituent, and the heteroaromatic ring group thereof preferably has a total carbon number of 4 to 40, and more preferably has a total carbon number of 4 to 30. As the substituent, for example, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable. As the heteroaromatic ring group, a pyridyl group, a pyrimidinyl group, a furyl group, or a benzofuranyl group is preferable, and a pyridyl group or a pyrimidinyl group is more preferable.

Preferred examples of the photoisomerizable compound include the following compounds. Bu represents an n-butyl group. The following compounds are compounds in which the steric configuration of each ethylenically unsaturated bond is E-form (trans-form), but changes to Z-form (cis-form) by exposure.

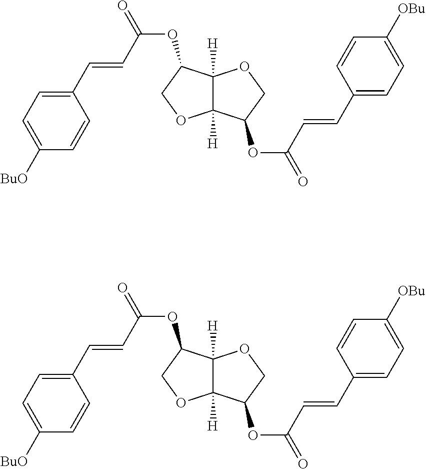

The photoisomerizable compound which also acts the chiral agent (that is, the photoisomerizable chiral agent) preferably includes a compound represented by Formula (1). The compound represented by Formula (1) is a photoisomerizable chiral agent including a polymerizable group.

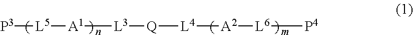

In Formula (1), L³ to L⁶ each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, —C≡C—, or —N═N—, A¹ and A² each independently represent a hydrocarbon ring group or a hetero ring group, P³ and P⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, —CN, or -Sp²-P⁵, where Sp² represents a single bond, an alkylene group having 1 to 20 carbon atoms, or a group in which at least one —CH₂— in an alkylene group having 2 to 20 carbon atoms is substituted with —O—, —S—, —NH—, —N(CH₃)—, —C(═O)—, —OC(═O)—, or —C(═O)O—, P⁵ represents a polymerizable group represented by Formula (P-1) or Formula (P-2), and at least one of P³ or P⁴ is -Sp²-P⁵, Q represents a divalent chiral source, and n and m each independently represent an integer of 1 to 3, where, in a case where n or m is an integer of 2 or more, a plurality of A¹'s may be the same or different from each other, a plurality of A²'s may be the same or different from each other, a plurality of L⁵'s may be the same or different from each other, and a plurality of L⁶'s may be the same or different from each other.

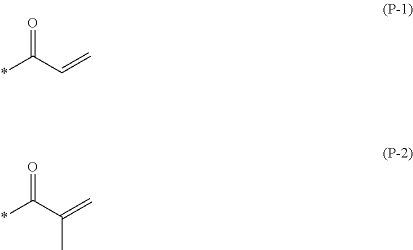

In Formula (P-1) and Formula (P-2), * represents a bonding position.

Hereinafter, the “group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—” represented by P³ and P⁴ may be referred to as “specific substituted alkyl group X1”. With regard to the specific substituted alkyl group X1, at least two —CH2-'s in an alkyl group having 2 to 20 carbon atoms may be each independently substituted with O—, —S—, —NH—, —N(CH₃)—, —C(═O)—, —OC(═O)—, or —C(═O)O—. That is, an atomic group in which —CH₂— is substituted may be the same as or different from another atomic group in which —CH₂— is substituted. A structure of the specific substituted alkyl group X1 may be a structure which does not include two adjacent oxygen atoms (that is, —O—O—).

Hereinafter, the “group in which at least one —CH₂— in an alkylene group having 2 to 20 carbon atoms is substituted with —O—, —S—, —NH—, —N(CH₃)—, —C(═O)—, —OC(═O)—, or —C(═O)O—” represented by Sp² may be referred to as “specific substituted alkylene group Y1”. With regard to the specific substituted alkylene group Y1, at least two —CH₂-'s in an alkylene group having 2 to 20 carbon atoms may be each independently substituted with O—, —S—, —NH—, —N(CH₃)—, —C(═O)—, —OC(═O)—, or —C(═O)O—. That is, an atomic group in which —CH₂— is substituted may be the same as or different from another atomic group in which —CH₂— is substituted. A structure of the specific substituted alkylene group Y1 may be a structure which does not include two adjacent oxygen atoms (that is, —O—O—).

From the viewpoint of improving reflection wavelength conversion ability, it is preferable that, in Formula (1), at least one of L³, . . . , or L⁶ is —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—. In addition, it is also preferable that, in Formula (1), at least one of L³, or L⁶ is —CH═CH—COO—, —OCO—CH═CH—, —CH═C(CN)—COO—, or —OCO—C(CN)═CH—. In addition, it is also preferable that, in Formula (1), at least one of L³, . . . , or L⁶ is —CH═C(CN)—COO— or —OCO—C(CN)═CH—. The “reflection wavelength conversion ability” means a property that the reflection wavelength changes due to an intentional external factor.

From the viewpoint of improving reflection wavelength conversion ability, it is preferable that, in Formula (1), at least one of L³ or L⁴ is —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—. In addition, it is also preferable that, in Formula (1), at least one of L³ or L⁴ is —CH═CH—COO—, —OCO—CH═CH—, —CH═C(CN)—COO—, or —OCO—C(CN)═CH—. In addition, it is also preferable that, in Formula (1), at least one of L³ or L⁴ is —CH═C(CN)—COO— or —OCO—C(CN)═CH—.

From the viewpoint of improving reflection wavelength conversion ability, it is preferable that, in Formula (1), L³ and L⁴ are each independently —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—. In addition, it is also preferable that, in Formula (1), L³ and L⁴ are each independently —CH═CH—COO—, —OCO—CH═CH—, —CH═C(CN)—COO—, or —OCO—C(CN)═CH—. In addition, it is also preferable that, in Formula (1), L³ and L⁴ are each independently —CH═C(CN)—COO— or —OCO—C(CN)═CH—.

From the viewpoint of ease of synthesis, it is preferable that, in Formula (1), at least one of L⁵ or L⁶ is a single bond, —COO—, —OCO—, or —O—. In addition, it is also preferable that, in Formula (1), L⁵ and L⁶ are each independently a single bond, —COO—, —OCO—, or —O—.

The hydrocarbon ring group includes at least one hydrocarbon ring. The hydrocarbon ring may be a fused ring. The number of atoms constituting the hydrocarbon ring is preferably 5 to 18, more preferably 5 to 10, and still more preferably 5 or 6. Examples of the hydrocarbon ring group include an aliphatic hydrocarbon ring group and an aromatic hydrocarbon ring group.

The aliphatic hydrocarbon ring group includes at least one aliphatic hydrocarbon ring. In a case where the aliphatic hydrocarbon ring has a polycyclic structure, it is preferable that at least one of rings included in the polycyclic structure is a 5- or higher membered ring. The number of atoms constituting the aliphatic hydrocarbon ring is preferably 5 to 10, and more preferably 5 or 6. Examples of the aliphatic hydrocarbon ring include a cyclopentane ring, a cyclohexane ring, a cycloheptane ring, a cyclooctane ring, a norbornene ring, and an adamantane ring. A cyclopentane ring or a cyclohexane ring is preferable.

The aromatic hydrocarbon ring group includes at least one aromatic hydrocarbon ring. In a case where the aromatic hydrocarbon ring has a polycyclic structure, it is preferable that at least one of rings included in the polycyclic structure is a 5- or higher membered ring. The number of atoms constituting the aromatic hydrocarbon ring is preferably 6 to 18, more preferably 6 to 10, and still more preferably 6. Examples of the aromatic hydrocarbon ring include a benzene ring, a naphthalene ring, an anthracene ring, a phenanthrene ring, and a fluorene ring. A benzene ring or a naphthalene ring is preferable, and a benzene ring is more preferable.

Specific examples of the hydrocarbon ring are shown below. However, the types of the hydrocarbon ring are not limited to the following specific examples.

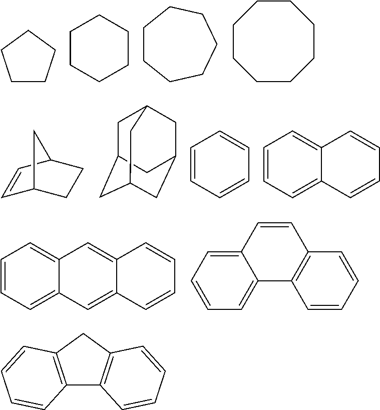

In Formula (1), the hydrocarbon ring group represented by A¹ and A² may have a substituent. Examples of the substituent include an alkyl group, an alkoxy group, an amino group, a nitro group, a hydroxy group, a carboxy group, and a halogen atom. The hydrocarbon ring group is preferably an unsubstituted hydrocarbon ring group.

The hetero ring group includes at least one hetero ring. The hetero ring may be a fused ring. The number of atoms constituting the hetero ring is preferably 5 to 18. Examples of a heteroatom included in the hetero ring include a nitrogen atom, an oxygen atom, and a sulfur atom. Examples of the hetero ring group include an aliphatic hetero ring group and an aromatic heterocyclic group.

The aliphatic hetero ring group includes at least one aliphatic hetero ring. In a case where the aliphatic hetero ring has a polycyclic structure, it is preferable that at least one of rings included in the polycyclic structure is a 5- or higher membered ring. The number of atoms constituting the aliphatic hetero ring is preferably 5 to 10. Examples of the aliphatic hetero ring include an oxolane ring, an oxane ring, a piperidine ring, and a piperazine ring. The aliphatic hetero ring may have a ring structure including —CO—. Examples of the aliphatic hetero ring having a ring structure including —CO— include a phthalimide ring.

The aromatic heterocyclic group includes at least one aromatic heterocyclic ring. In a case where the aromatic heterocyclic ring has a polycyclic structure, it is preferable that at least one of rings included in the polycyclic structure is a 5- or higher membered ring. The number of atoms constituting the aromatic heterocyclic ring is preferably 5 to 18. Examples of the aromatic heterocyclic ring include a pyridine ring, a pyridazine ring, a pyrimidine ring, a pyrazine ring, a triazine ring, a thiophene ring, a thiazole ring, and an imidazole ring.

Specific examples of the hetero ring are shown below. However, the types of the heterocyclic ring are not limited to the following specific examples.

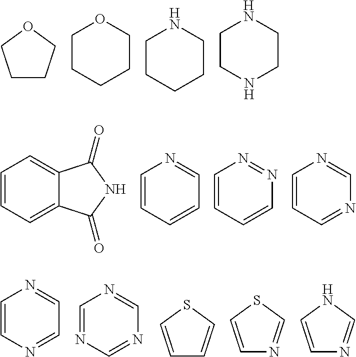

In Formula (1), the hetero ring group represented by A¹ and A² may have a substituent. Examples of the substituent include the substituents of the hydrocarbon ring group described above. The hetero ring group is preferably an unsubstituted hetero ring group.

In Formula (1), the alkyl group having 1 to 20 carbon atoms, represented by P³ and P⁴, (however, excluding the alkyl group having 2 to 20 carbon atoms, which defines the specific substituted alkyl group X1) may be a linear, branched, or cyclic alkyl group.

In Formula (1), the alkyl group having 2 to 20 carbon atoms, which defines the specific substituted alkyl group X1, represented by P³ and P⁴ may be a linear, branched, or cyclic alkyl group.

In Formula (1), the alkylene group having 1 to 20 carbon atoms, represented by Sp², (however, excluding the alkylene group having 2 to 20 carbon atoms, which defines the specific substituted alkylene group Y1) may be a linear, branched, or cyclic alkylene group.

In Formula (1), the alkylene group having 2 to 20 carbon atoms, which defines the specific substituted alkylene group Y1, (hereinafter, it may be simply referred to as “alkylene group” in this paragraph) represented by Sp² may be a linear, branched, or cyclic alkylene group. From the viewpoint of suppression of defects in the liquid crystal phase and ease of acquisition, the alkylene group is preferably a linear alkylene group or a branched alkylene group, and more preferably a linear alkylene group. From the viewpoint of suppression of defects in the liquid crystal phase and ease of acquisition, the alkylene group preferably has 2 to 10 carbon atoms, more preferably has 2 to 8 carbon atoms, and still more preferably has 4 to 6 carbon atoms. The alkylene group is preferably an unsubstituted alkylene group.

From the viewpoint of suppression of defects in the liquid crystal phase and ease of acquisition, it is preferable that, in Formula (1), the specific substituted alkylene group Y1 represented by Sp² is a group having a structure in which at least one —CH₂— in an alkylene group having 2 to 20 carbon atoms is substituted with —O—. In addition, it is also preferable that, in Formula (1), the specific substituted alkylene group Y1 represented by Sp² is a group having a structure in which at least two —CH₂-'s in an alkylene group having 2 to 20 carbon atoms is substituted with —O—.

From the viewpoint of suppression of defects in the liquid crystal phase and ease of acquisition, it is preferable that, in Formula (1), the specific substituted alkylene group Y1 represented by Sp² is an alkyleneoxy group having 1 to 19 carbon atoms or an alkylenedioxy group having 1 to 18 carbon atoms. In addition, it is also preferable that, in Formula (1), the specific substituted alkylene group Y1 represented by Sp² is an alkyleneoxy group having 1 to 19 carbon atoms. In addition, it is also preferable that, in Formula (1), the specific substituted alkylene group Y1 represented by Sp² is an alkylenedioxy group having 1 to 18 carbon atoms.

The alkyleneoxy group having 1 to 19 carbon atoms may be a linear or branched alkyleneoxy group. The alkyleneoxy group is preferably a linear alkyleneoxy group. The alkyleneoxy group preferably has 2 to 10 carbon atoms, more preferably 4 to 8 carbon atoms, and particularly preferably 4 to 6 carbon atoms. Examples of the alkyleneoxy group include —OC₂H₂—, —OC₃H₆—, —OC₄Hg—, —OC₅H₁₀—, and —OC₆H₁₂—.

The alkylenedioxy group having 1 to 18 carbon atoms may be a linear or branched alkylenedioxy group. The alkylenedioxy group is preferably a linear alkylenedioxy group. The alkylenedioxy group preferably has 2 to 10 carbon atoms, more preferably 4 to 8 carbon atoms, and particularly preferably 4 to 6 carbon atoms.

From the viewpoint of reactivity and ease of acquisition, in Formula (1), P⁵ is preferably the polymerizable group represented by Formula (P-1).

From the viewpoint of improving the durability of the cured substance, it is preferable that, in Formula (1), P³ and P⁴ are each independently -Sp²-P⁵.

In Formula (1), the divalent chiral source represented by Q contributes to expression of chirality. A chemical structure of the divalent chiral source is not limited as long as the divalent chiral source contributes to the expression of chirality. Specific examples of the divalent chiral source are shown below. However, the type of the divalent chiral source is not limited to the following specific examples.

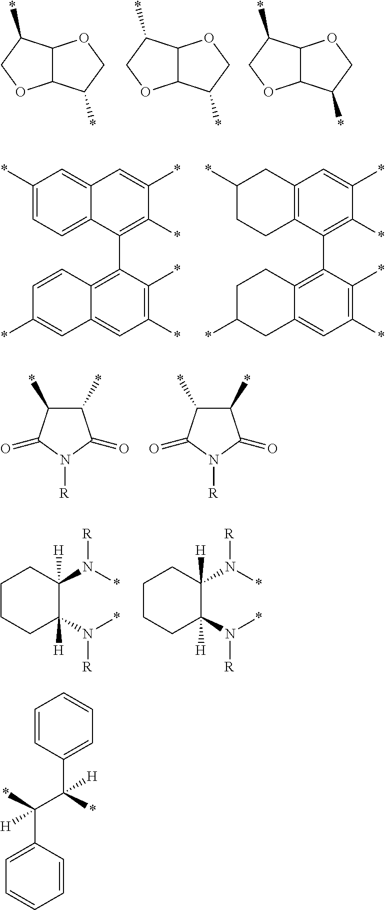

In the above-described specific examples, * represents a bonding position and R represents a substituent. In the above-described specific examples, a binaphthyl skeleton may be an (R)-form or an (S)-form. In the above-described specific examples, the binaphthyl skeleton may be a mixture of the (R)-form and the (S)-form.

It is preferable that, in Formula (1), Q is a divalent chiral source including a binaphthyl skeleton, an isosorbide skeleton, or an isomannide skeleton. Furthermore, it is preferable that, in Formula (1), Q is a divalent chiral source represented by Formula (Q-1) or Formula (Q-2), and it is more preferable to be a divalent chiral source represented by Formula (Q-1).

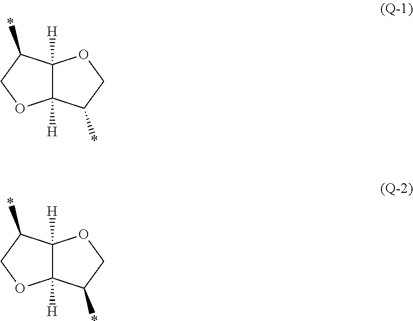 [SMILES: *[C@@H]1CO[C@H]2[C@@H]1OC[C@@H]2* ; *[C@@H]1CO[C@H]2[C@@H]1OC[C@H]2*]

In Formula (Q-1) and Formula (Q-2), * represents a bonding position.

From the viewpoint of improving reflection wavelength conversion ability, in Formula (1), n and m are each independently preferably 2 or 3, and more preferably 2.

Examples of the compound represented by Formula (1) include a compound represented by Formula (1-1) or Formula (1-2). The compound represented by Formula (1) is preferably a compound represented by Formula (1-1) or Formula (1-2).

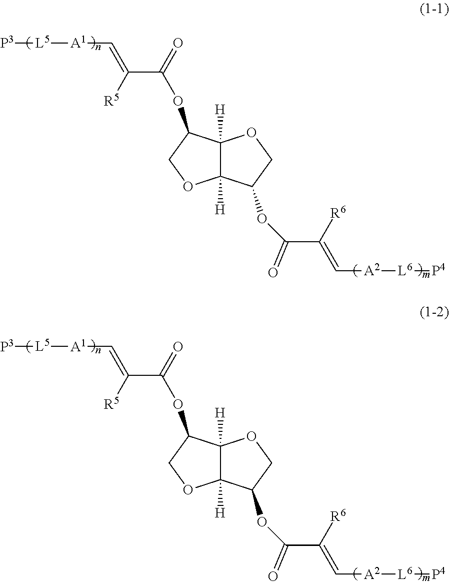

In Formula (1-11 and Formula (1-21, L⁵ has the same meaning as L⁵ in Formula (11. L⁶ has the same meaning as L⁶ in Formula (1), A¹ has the same meaning as A¹ in Formula (1), A² has the same meaning as A² in Formula (1), P³ has the same meaning as P³ in Formula (1), P⁴ has the same meaning as P⁴ in Formula (1), n has the same meaning as n in Formula (1), m has the same meaning as m in Formula (1), and R⁵ and R⁶ each independently represent a hydrogen atom, —CN, or an alkyl group having 1 to 10 carbon atoms.

In Formula (1-1) and Formula (1-2), the alkyl group having 1 to 10 carbon atoms, represented by R⁵ and R⁶, may be a linear, branched, or cyclic alkyl group. From the viewpoint of expression of large helical inducing force, the alkyl group is preferably a linear alkyl group or a branched alkyl group, and more preferably a linear alkyl group. The alkyl group preferably has 1 to 3 carbon atoms, and more preferably has 1 carbon atom. That is, the alkyl group is preferably a methyl group.

From the viewpoint of improving reflection wavelength conversion ability, it is preferable that, in Formula (1-1) and Formula (1-2), at least one of R⁵ or R⁶ is —CN. In addition, it is also preferable that, in Formula (1-1) or Formula (1-2), R⁵ and R⁶ are —CN.

Specific examples of the compound represented by Formula (1) are as follows. However, the types of the compound represented by Formula (1) are not limited to the following specific examples.

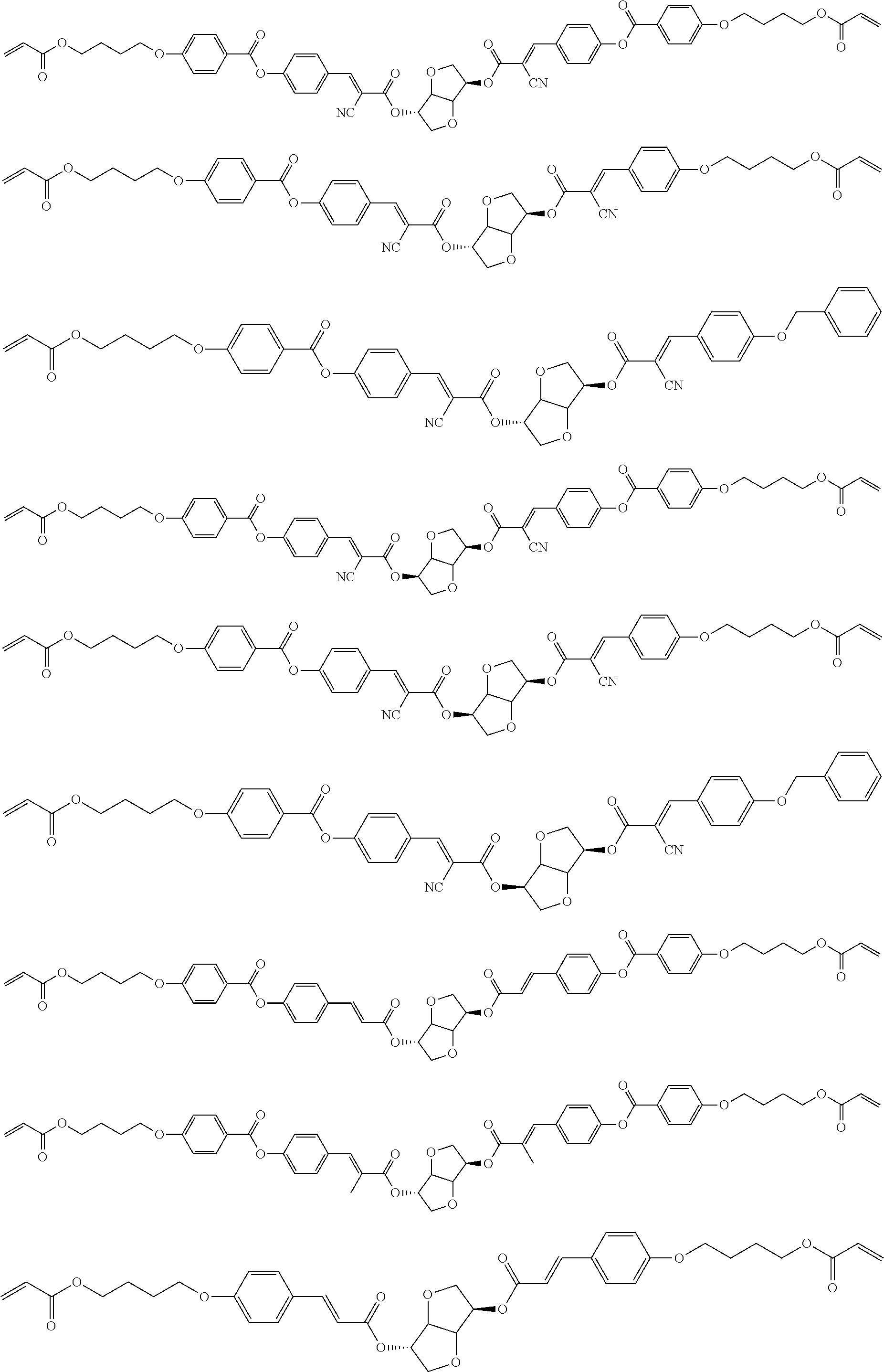

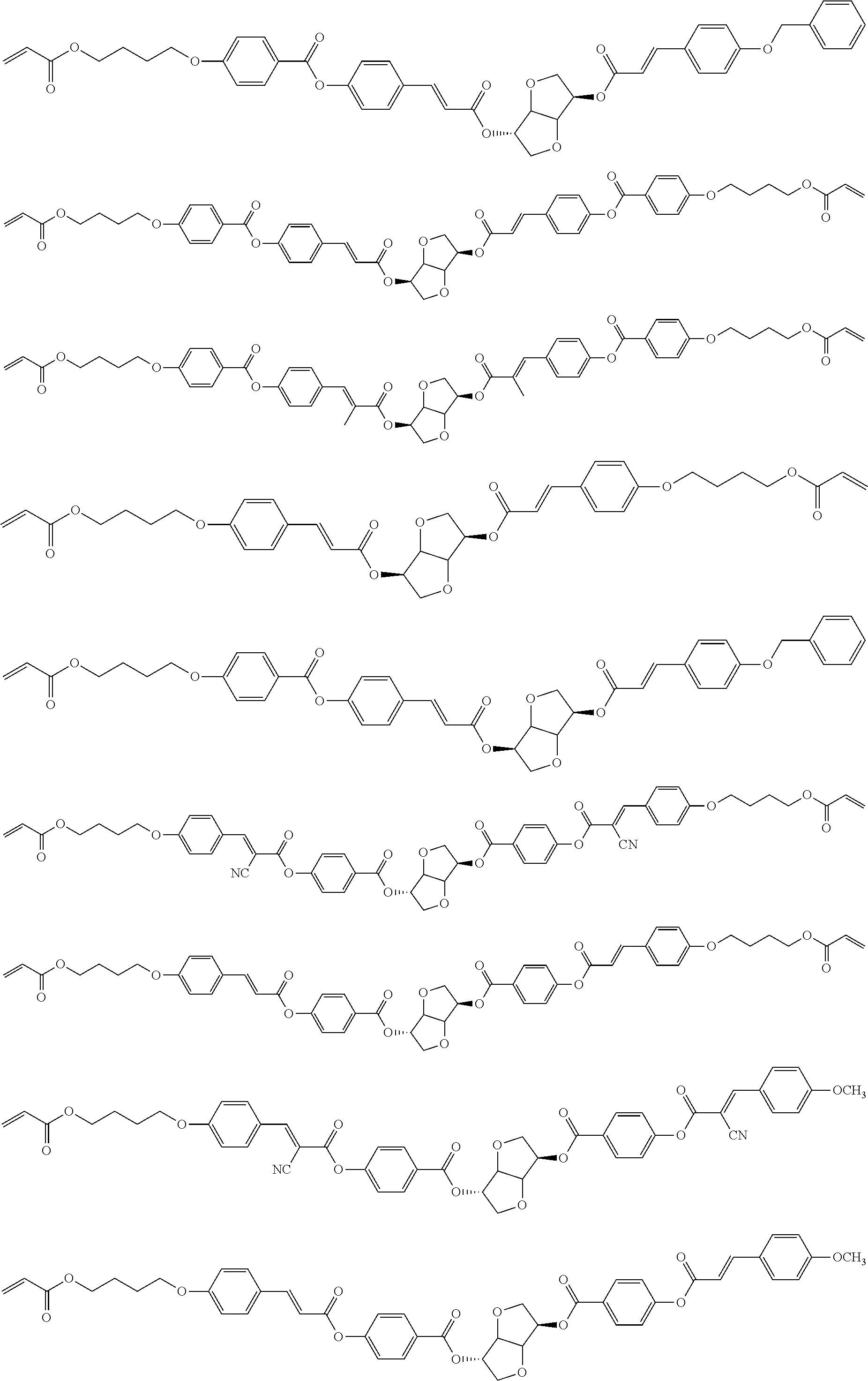

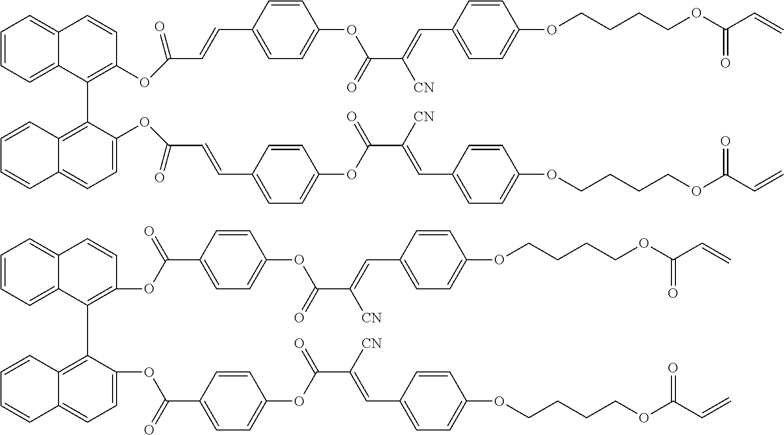

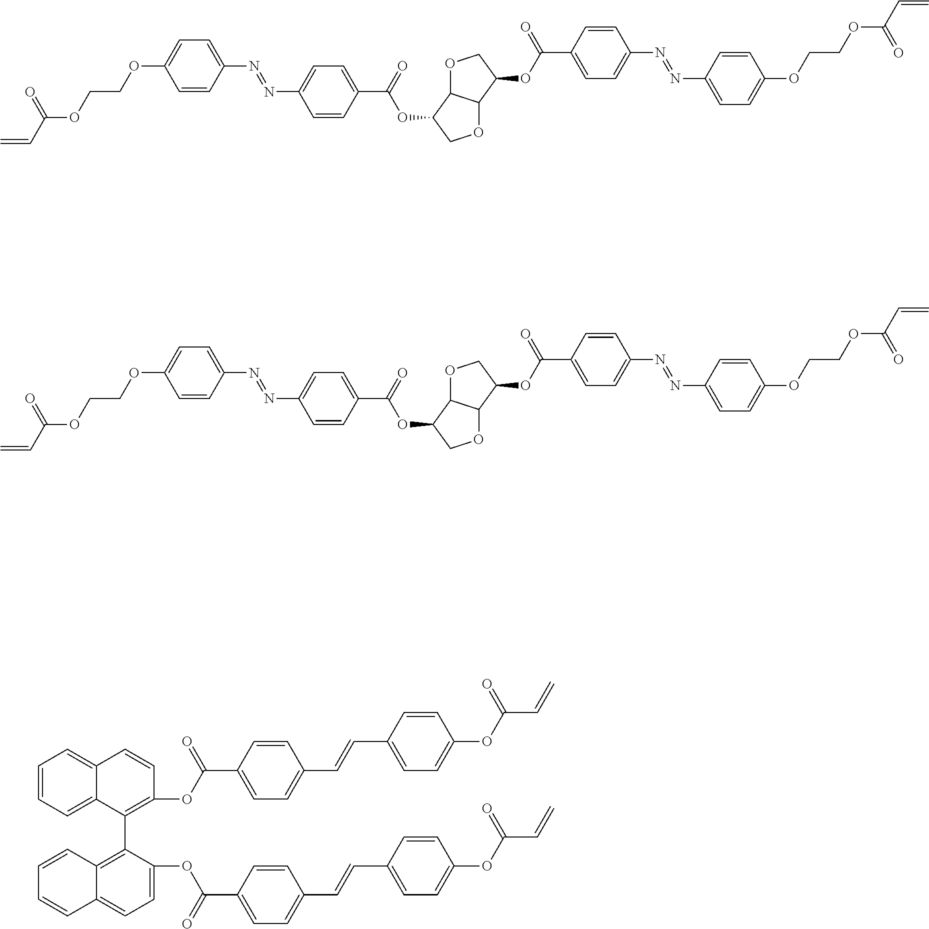

The photoisomerizable chiral agent is preferably a compound represented by Formula (C1). The compound represented by Formula (C1) has two polymerizable groups, and can suppress the change in tint of the decorative material in the thermal environment. In addition, the compound represented by Formula (C1) can impart, to the decorative material, design in which the color changes depending on a visual angle, through the photoisomerization.

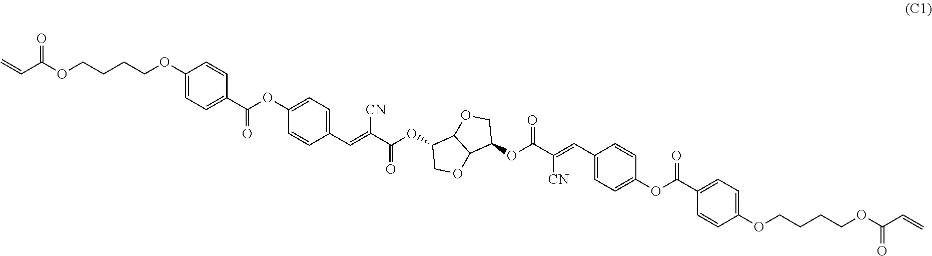 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccc(OCCCCOC(=O)C=C)cc4)cc3)cc2)cc1]

The composition may include one kind or two or more kinds of chiral agents.

The content of the chiral agent can be appropriately selected according to the desired pitch of the structure and helical structure of the liquid crystal compound to be used. However, from the viewpoint of ease of forming a liquid crystal layer and ease of adjusting the pitch of the helical structure, and viewpoint of suppressing change in reflectivity after molding, the content of the chiral agent is preferably 1% by mass to 20% by mass, more preferably 2% by mass to 10% by mass, still more preferably 3% by mass to 9% by mass, and particularly preferably 4% by mass to 8% by mass with respect to the total mass of the solid content of the composition.

From the viewpoint of suppressing change in reflectivity after molding, the content of the chiral agent having a polymerizable group is preferably 0.2% by mass to 15% by mass, more preferably 0.5% by mass to 10% by mass, still more preferably 1% by mass to 8% by mass, and particularly preferably 1.5% by mass to 5% by mass with respect to the total mass of the solid content of the composition.

In a case of containing a chiral agent not having a polymerizable group, from the viewpoint of suppressing change in reflectivity after molding, the content of the chiral agent not having a polymerizable group is preferably 0.2% by mass to 20% by mass, more preferably 0.5% by mass to 10% by mass, and particularly preferably 2% by mass to 8% by mass with respect to the total mass of the solid content of the composition.

In addition, the pitch of the helical structure of the cholesteric liquid crystalline phase, and a reflection wavelength and its range can be easily changed not only by adjusting the type of the liquid crystal compound used but also by adjusting the content of the chiral agent. Although it cannot be said unconditionally, in a case where the content of the chiral agent in the liquid crystal layer is doubled, the above-described pitch may be halved.

The composition preferably includes a polymerization initiator, and more preferably includes a photopolymerization initiator. As the polymerization initiator, a known polymerization initiator can be used. In addition, the polymerization initiator is preferably a photopolymerization initiator capable of initiating a polymerization reaction by ultraviolet irradiation.

Examples of the photopolymerization initiator include α-carbonyl compounds (described in U.S. Pat. Nos. 2,367,661A and 2,367,670A), acyloin ether compounds (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine compounds and phenazine compounds (described in JP1985-105667A (JP-S60-105667A) and U.S. Pat. No. 4,239,850A), and oxadiazole compounds (described in U.S. Pat. No. 4,212,970A).

As the photoradical polymerization initiator, a known photoradical polymerization initiator can be used. Preferred examples of the photoradical polymerization initiator include α-hydroxyalkylphenone compounds, α-aminoalkylphenone compounds, acylphosphine oxide compounds, thioxanthone compounds, and oxime ester compounds.

As the photocationic polymerization initiator, a known photocationic polymerization initiator can be used. Preferred examples of the photocationic polymerization initiator include iodonium salt compounds and sulfonium salt compounds.

The composition may include one kind or two or more kinds of polymerization initiators.

The content of the polymerization initiator can be appropriately selected according to the desired pitch of the structure and helical structure of the liquid crystal compound to be used. However, from the viewpoint of ease of adjusting the pitch of the helical structure, polymerization rate, and strength of the liquid crystal layer after curing, the content of the polymerization initiator is preferably 0.05% by mass to 10% by mass, more preferably 0.05% by mass to 5% by mass, still more preferably 0.1% by mass to 4% by mass, and particularly preferably 0.2% by mass to 3% by mass with respect to the total mass of the solid content of the composition. From the viewpoint of reducing the content of the low-molecular-weight compound in the cholesteric liquid crystal layer and suppressing the change in tint of the decorative material in the thermal environment, a content of the polymerization initiator is preferably 0.05% by mass to 1% by mass, and more preferably 0.05% by mass to 0.5% by mass with respect to the total mass of solid contents of the composition.

The composition may include a crosslinking agent in order to improve the strength and durability of the liquid crystal layer after curing. As the crosslinking agent, a crosslinking agent which cures the liquid crystal composition with ultraviolet rays, heat, humidity, and the like can be suitably used.

The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate, ethylene glycol diglycidyl ether, and 3′,4′-epoxycyclohexylmethyl 3,4-epoxycyclohexanecarboxylate; oxetane compounds such as 2-ethylhexyloxetane and xylylenebisoxetane; aziridine compounds such as 2,2-bishydroxymethylbutanol-tris[3-(1-aziridinyl)propionate] and 4,4-bis(ethyleneiminocarbonylamino)diphenylmethane; isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst can be used depending on reactivity of the crosslinking agent, and in addition to improving the strength and durability of the liquid crystal layer, productivity can be improved.

The composition may include one kind or two or more kinds of crosslinking agents.

From the viewpoint of the strength and durability of the liquid crystal layer, the content of the crosslinking agent is preferably 1% by mass to 20% by mass and more preferably 3% by mass to 15% by mass with respect to the total mass of the solid content of the composition.

The composition may contain other additives. As the other additives, a known additive can be used, and examples thereof include a surfactant, a polymerization inhibitor, an antioxidant, a horizontal alignment agent, an ultraviolet absorber, a light stabilizer, a colorant, and metal oxide particles.

The composition may contain a solvent. The solvent is not particularly limited and can be selected according to the purpose, but an organic solvent is preferably used.

The organic solvent is not particularly limited and can be selected according to the purpose, and examples thereof include ketones such as methyl ethyl ketone and methyl isobutyl ketone, alkyl halides, amides, sulfoxides, heterocyclic compounds, hydrocarbons, esters, ethers, and alcohols. The solvent may be used alone or in combination of two or more kinds thereof. Among these, in consideration of burden on the environment, ketones are particularly preferable. In addition, the above-described component may function as the solvent.

The composition may include one kind or two or more kinds of solvents.

(Peelable Base Material)

The decorative material according to the embodiment of the present disclosure may include a peelable base material. The peelable base material can be peeled off from the decorative material, as necessary, to expose a surface of the layer covered with the peelable base material. In addition, the peelable base material can also function as, for example, a support or a protective layer. It is preferable that the decorative material including the peelable base material has a structure in which the peelable base material, the cholesteric liquid crystal layer, and the pressure sensitive adhesive layer are arranged in this order. The peelable base material may be in contact with the cholesteric liquid crystal layer. Another layer may be disposed between the peelable base material and the cholesteric liquid crystal layer.

Examples of a component of the peelable base material include a resin. Examples of the resin include polyethylene terephthalate (PET), polyethylene naphthalate (PEN), an acrylic resin, a urethane resin, a urethane-acrylic resin, polycarbonate (PC), an acrylic-polycarbonate resin, polyethylene (for example, polypropylene), triacetyl cellulose (TAC), a cycloolefin polymer (COP), and an acrylonitrile-butadiene-styrene copolymer resin (ABS resin). From the viewpoint of moldability and strength, the peelable base material preferably includes at least one selected from the group consisting of polyethylene terephthalate (PET), an acrylic resin, a urethane resin, a urethane-acrylic resin, polycarbonate, an acrylic-polycarbonate resin, and polypropylene, and more preferably includes polyethylene terephthalate (PET).

The peelable base material may have a monolayer structure or a multilayer structure. For example, the peelable base material may include an easy-adhesive layer. For example, the peelable base material may include a layer containing an acrylic resin and a layer containing polycarbonate.

The peelable base material may contain an additive as necessary. Examples of the additive include mineral oil, hydrocarbons, fatty acids, alcohols, fatty acid esters, fatty acid amides, metallic soaps, natural waxes, silicone, magnesium hydroxide, aluminum hydroxide, a halogen-based organic flame retardant, a phosphorus-based organic flame retardant, metal powder, talc, calcium carbonate, potassium titanate, glass fibers, carbon fibers, wood powder, an antioxidant, an ultraviolet inhibitor, a lubricant, a dispersant, a coupling agent, a foaming agent, and a colorant.

The peelable base material may be a commercially available product. Examples of the commercially available product include COSMOSHINE (polyethylene terephthalate film, manufactured by TOYOBO Co., Ltd.).

A thickness of the peelable base material is preferably 1 μm or more, more preferably 10 m or more, still more preferably 20 μm or more, and particularly preferably 50 μm or more. The thickness of the peelable base material is preferably 500 μm or less, more preferably 450 μm or less, and still more preferably 200 μm or less.

(Base Material)

The decorative material according to the embodiment of the present disclosure may further include a base material. It is preferable that the decorative material including the base material has a structure in which the cholesteric liquid crystal layer, the pressure sensitive adhesive layer, and the base material are arranged in this order. It is also preferable that the decorative material including the base material has a structure in which the base material, the cholesteric liquid crystal layer, and the pressure sensitive adhesive layer are arranged in this order. The base material may be in contact with the pressure sensitive adhesive layer or the cholesteric liquid crystal layer. Another layer may be disposed between the base material and the pressure sensitive adhesive layer or cholesteric liquid crystal layer.

Examples of a component of the base material include a resin. Examples of the resin include resins described in the section of “Peelable base material” above. A preferred aspect of the resin contained in the base material is the same as the preferred aspect of the resin described in the section of “Peelable base material” above.

The base material may contain an additive as necessary. Examples of the additive include additives described in the section of “Peelable base material” above.

The base material may be a commercially available product. Examples of the commercially available product include TECHNOLLOY (registered trademark) series (acrylic resin film or acrylic resin/polycarbonate resin laminated film, manufactured by Sumitomo Chemical Co., Ltd.), ABS films (manufactured by Okamoto Industries, Inc.), ABS sheets (manufactured by SEKISUI SEIKEI CO., LTD.), Teflex (registered trademark) series (PET film, manufactured by TEIJIN FILM SOLUTIONS LIMITED), Lumirror (registered trademark) easily moldable type (PET film, manufactured by TORAY INDUSTRIES, INC), and Purethermo (polypropylene film, manufactured by Idemitsu Kosan Co., Ltd.).

A thickness of the base material is preferably 1 μm or more, more preferably 10 μm or more, still more preferably 20 μm or more, and particularly preferably 50 μm or more. The thickness of the peelable base material is preferably 500 μm or less, more preferably 450 μm or less, and still more preferably 200 μm or less.

The base material preferably has an uneven structure. The “uneven structure” means a structure which is apparently uneven due to the presence of a concavo portion, the presence of a convex portion, or the presence of both the concavo portion and the convex portion. The uneven structure may be formed with a portion protruding with respect to a certain reference plane, may be formed with a portion recessed with respect to a certain reference plane, or may be formed with both protruding and recessed portions with respect to a certain reference plane. The “uneven structure” means a concavo-convex structure in which an average value of height differences between adjacent local maximum portion and local minimum portion is 3 μm to 100 μm. The average value of height differences between adjacent local maximum portion and local minimum portion is measured by a method according to a measuring method of a height (H) of a convex portion, which will be described later.

Examples of a shape of the convex portion in a plan view include a linear structure, a spiral structure, a concentric circular structure, and a wavy linear structure. The “linear” means a shape having a length in a specific direction. Specifically, preferred examples thereof include an aspect in which a ratio (L/W) of a length (L) to an average line width (W) is 5 or more. Examples of a shape of the convex portion in a cross-sectional view include a triangle, a square, a rectangle, a trapezoid, a semicircle, and a semi-elliptical shape. For example, in a case where the base material has a region where a plurality of linear convex structures are arranged and a region where a plurality of linear convex structures, which is different from the linear convex structures of the region, are arranged in a longitudinal direction, it is possible to obtain a decorative material having visibility in which one region is bright and the other region is dark depending on the viewing direction of each region. In addition, for example, in a case where the base material has a region having a concentric circular convex structure, it is possible to obtain a decorative material having visibility in which bright and dark portions are generated radially from the center of concentric circles in the region and the bright and dark portions change depending on the viewing direction.

It is preferable that the convex portions in the uneven structure are arranged at a periodic pitch. The pitch is an interval between the convex portions adjacent to each other in the uneven structure. The interval between the convex portions is a distance between the highest point of the convex portion and the highest point of the convex portion. For example, in a case where the convex portion has a hemispherical shape, the pitch corresponds to a distance between vertices of two hemispherical convex portions which are closest to each other. For example, in a case where the convex portion has a triangular shape, the pitch corresponds to a distance between vertices of two triangular convex portions which are closest to each other.

From the viewpoint of obtaining visibility rich in color change depending on the visual angle and viewpoint of lustrousness, a height (H) of the convex portion in the uneven structure is preferably 3 μm to 100 μm, more preferably 3 μm to 50 μm, still more preferably 3 μm to 40 μm, and particularly preferably 4 μm to 20 μm. The height of the convex portion is represented by an average value of height differences between adjacent local maximum portion and local minimum portion on a measurement target surface, measured with a laser microscope (for example, VK-X1000 manufactured by KEYENCE CORPORATION).

From the viewpoint of obtaining visibility rich in color change depending on the visual angle and viewpoint of lustrousness, a width (W) of the convex portion in the uneven structure is preferably 1 μm or more, more preferably 2 μm to 200 μm, still more preferably 30 μm to 100 m, and particularly preferably 4 μm to 40 μm. The width of the convex portion is represented by an average value of distances between adjacent local minimum portions on a measurement target surface, measured with a laser microscope (for example, VK-X1000 manufactured by KEYENCE CORPORATION).

From the viewpoint of obtaining visibility rich in color change depending on the visual angle and viewpoint of lustrousness, a length (L) of the convex portion in the uneven structure is preferably 5 μm or more, more preferably 10 μm to 100 μm, still more preferably 30 μm to 20 μm, and particularly preferably 50 μm to 10 μm. The length of the convex portion is measured with a laser microscope (for example, VK-X1000 manufactured by KEYENCE CORPORATION).

From the viewpoint of obtaining visibility rich in color change depending on the visual angle and viewpoint of lustrousness, a ratio (width:height) of the height of the convex portion in the uneven structure and the width of the convex portion in the uneven structure is preferably 20:1 to 1:2, more preferably 10:1 to 1:0.8, still more preferably 8:1 to 1:1, and particularly preferably 4:1 to 1:1.2.

A thickness H_{T} of the base material and a height H_{D} of the convex portion in a fine uneven structure of the base material preferably satisfy a relationship of 0.1<H_{D}/H_{T}, more preferably satisfy a relationship of 0.5<H_{D}/H_{T}<200, still more preferably satisfy a relationship of 1<H_{D}/H_{T}<100, and particularly preferably satisfy a relationship of 5<H_{D}/H_{T}<50. The thickness of the base material represents a distance between an upper surface of the base material and a lower surface of the base material.

In a case where the base material has a linear convex structure, a ratio (L/W) of the length (L) of the convex portion in the uneven structure to the width (W) of the convex portion in the uneven structure is preferably 5 or more, more preferably 8 or more, still more preferably 10 or more, and particularly preferably 20 or more. Within the above-described range, lustrousness is high, and visibility rich in color change depending on the visual angle is obtained.

In a case where the base material has a linear convex structure, a single linear convex shape preferably has at least a region where an in-plane direction of the length (L) forms an angle of 450 or more, more preferably has at least a region where an in-plane direction of the length (L) forms an angle of 600 or more, still more preferably has at least a region where an in-plane direction of the length (L) forms an angle of 700 or more, and particularly preferably has at least a region where an in-plane direction of the length (L) forms an angle of 90° or more. Within the above-described range, lustrousness is high, and visibility rich in color change depending on the visual angle is obtained. Here, in the single linear convex shape, within the line width (W), adjacent convex shapes in which an angle formed by the in-plane direction of the length (L) is less than 200 are considered within the range of the single convex shape.

In a case where the substrate has a linear convex structure, it is preferable to have at least a region in-plane where an angle formed by the length (L) direction of adjacent linear convex structures is 450 or more, it is more preferable to have at least a region in-plane where an angle formed by the length (L) direction of adjacent linear convex structures is 600 or more, it is still more preferable to have at least a region in-plane where an angle formed by the length (L) direction of adjacent linear convex structures is 700 or more, and it is particularly preferable to have at least a region in-plane where an angle formed by the length (L) direction of adjacent linear convex structures is 800 or more. Within the above-described range, lustrousness is high, and visibility rich in color change depending on the visual angle is obtained. Here, the “adjacent” means that the linear convex structures are adjacent to each other at a distance within 10 times an average value Wa=(W1+W2)/2 of line widths (W1 and W2) of adjacent linear convex shapes.

In a case where the substrate has a linear convex structure, it is preferable to include a region where a relationship between a distance (D) between vertices of adjacent convex structures and the average line width Wa=(W1+W2)/2 of the adjacent convex structures is D>1.5Wa, it is more preferable to include a region where 1.75Wa≤D≤10Wa, it is still more preferable to include a region where 1.8Wa≤D≤8Wa, and it is particularly preferable to include a region where 2DWa≤D≤6Wa. Within the above-described range, lustrousness is high, and visibility rich in color change depending on the visual angle is obtained.

(Alignment Layer)

The decorative material according to the embodiment of the present disclosure may include an alignment layer. The alignment layer is used for aligning the liquid crystal compound in the formation of the liquid crystal layer. A thickness of the alignment layer is preferably in a range of 0.01 μm to 10 μm.

The alignment layer can be provided by a method of a rubbing treatment of an organic compound (preferably a polymer), an oblique vapor deposition of an inorganic compound such as SiO, a formation of a layer having a microgroove, and the like. Furthermore, an alignment layer in which an alignment function occurs by application of an electric field, application of a magnetic field, or light irradiation has also been known.

Depending on the material of an underlayer such as the base material and the liquid crystal layer, the alignment layer may be provided, or the underlayer may be subjected to a direct alignment treatment (for example, rubbing treatment) to function as an alignment layer. Polyethylene terephthalate (PET) can be mentioned as an example of such a support as the underlayer.

In addition, in a case where a layer is directly laminated on the liquid crystal layer, in some cases, the liquid crystal layer as the underlayer behaves as the alignment layer and the liquid crystal compound for forming an upper layer can be aligned. In such a case, the liquid crystal compound in the upper layer can be aligned without providing the alignment layer or performing a special alignment treatment (for example, rubbing treatment).

Hereinafter, as a preferred example, a rubbing-treated alignment layer which is used by subjecting a surface to a rubbing treatment, and a photoalignment layer will be described.

Examples of a polymer which can be used in the rubbing-treated alignment layer include a methacrylate-based copolymer, a styrene-based copolymer, polyolefin, polyvinyl alcohol and modified polyvinyl alcohol, poly(N-methylol acrylamide), polyester, polyimide, a vinyl acetate copolymer, carboxymethyl cellulose, and polycarbonate, which are described in paragraph 0022 of JP1996-338913A (JP-H8-338913A). A silane coupling agent can be used as the polymer. As the polymer which can be used in the rubbing-treated alignment layer, a water-soluble polymer (for example, poly(N-methylol acrylamide), carboxymethyl cellulose, gelatin, polyvinyl alcohol, and modified polyvinyl alcohol) is preferable, gelatin, polyvinyl alcohol, or modified polyvinyl alcohol is more preferable, and polyvinyl alcohol or modified polyvinyl alcohol is particularly preferable.

The molecules of the liquid crystal compound are aligned by coating a rubbing-treated surface of the alignment layer with the composition. Thereafter, as necessary, by reacting the alignment layer polymer with a polyfunctional monomer included in the liquid crystal layer, or by crosslinking the alignment layer polymer using a crosslinking agent, the above-described liquid crystal layer can be formed.

The surface of the alignment layer, the base material, or other layers, to be coated with the composition, may be subjected to a rubbing treatment as necessary. The rubbing treatment can be generally performed by rubbing a surface of a film containing a polymer as a main component with paper or cloth in a certain direction. The general method of the rubbing treatment is described in, for example, “Handbook of Liquid crystals” (published by Maruzen, Oct. 30, 2000).

As a method of changing a rubbing density, the method described in “Handbook of Liquid crystals” (published by Maruzen) can be used. The rubbing density (L) is quantified by Expression (A).

L=Nl(1+2πrn/60ν) Expression (A)

In Expression (A), N is the number of times of rubbing, l is a contact length of a rubbing roller, r is a radius of the roller, n is a rotation speed (revolutions per minute: rpm) of the roller, and v is a stage moving speed (speed per second).

In order to increase the rubbing density, it is sufficient that the number of times of rubbing is increased, the contact length of the rubbing roller is increased, the radius of the roller is increased, the rotation speed of the roller is increased, or the stage moving speed is decreased. On the other hand, in order to decrease the rubbing density, it is sufficient that the reverse is carried out. In addition, with regard to conditions of the rubbing treatment, the description in JP4052558B can be referred to.

A photoalignment material used for the photoalignment layer formed by light irradiation is described in many references. Preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadiimide compounds having a photo alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds, or photo-crosslinkable polyimides, polyamides, esters are particularly preferable.

The photoalignment layer is produced by subjecting the photoalignment layer formed of the above-described material to an irradiation of linearly polarized light or non-polarized light. In the present specification, the “irradiation of linearly polarized light” is an operation for causing a photo-reaction of the photoalignment material. The wavelength of the light used depends on the photoalignment material used, and is not particularly limited as long as a wavelength necessary for the photo-reaction. The light used for light irradiation is preferably light having a peak wavelength of 200 nm to 700 nm and the light is more preferably ultraviolet light having a peak wavelength of 400 nm or less.

Examples of a light source used for light irradiation include known light sources, for example, lamps such as a tungsten lamp, a halogen lamp, a xenon lamp, a xenon flash lamp, a mercury lamp, a mercury-xenon lamp, and a carbon arc lamp, various lasers (such as semiconductor laser, helium neon laser, argon ion laser, helium cadmium laser, and YAG laser), light emitting diodes, cathode ray tube, and the like.

As a method for obtaining the linearly polarized light, a method of using a polarizing plate (for example, iodine polarizing plate, dichroic coloring agent polarizing plate, and wire grid polarizing plate), a method of using a prismatic element (for example, Glan-Thompson prism) or a reflective type polarizer using Brewster's angle, or a method of using light emitted from a polarized laser light source can be adopted. In addition, by using a filter, a wavelength conversion element, or the like, only light having a required wavelength may be irradiated selectively.

In a case where the irradiated light is the linearly polarized light, a method of irradiating, from the upper surface or the back surface, the alignment layer with the light perpendicularly or obliquely to the surface of the alignment layer is exemplified. The incidence angle of the light varies depending on the photoalignment material, but is preferably 0° to 900 (perpendicular) and more preferably 400 to 900 with respect to the alignment layer. In a case of using the non-polarized light, the non-polarized light is irradiated obliquely. The incidence angle of the light is preferably 10° to 80°, more preferably 20° to 60°, and particularly preferably 30° to 50°. An irradiation time is preferably 1 minute to 60 minutes and more preferably 1 minute to 10 minutes.

(Colored Layer)

The decorative material according to the embodiment of the present disclosure may include a colored layer. In the decorative material, it is preferable that at least one of the colored layers is a layer for viewing through the liquid crystal layer. By viewing at least one of the colored layers through the liquid crystal layer, it is presumed that, based on the anisotropy depending on an angle of incidence ray in the liquid crystal layer, the change in color occurs depending on the angle at which the colored layer is viewed, and special designability is exhibited.

In addition, in a case where the decorative material according to the embodiment of the present disclosure has two or more colored layers, preferred examples of an aspect of the two or more colored layers include an aspect in which at least one of the colored layers is a layer for viewing through the liquid crystal layer, and at least one other layer of the colored layers is a layer (also referred to as a “color filter layer”) closer to a viewing direction than the liquid crystal layer. The “closer to a viewing direction” means that it is close to the viewer in a case of being viewed. The colored layer (color filter layer) closer to a viewing direction than the liquid crystal layer is a layer having high transparency to light having at least a specific wavelength. The layer configuration thereof is not particularly limited, and may be a single color filter layer or may be a color filter layer having a color filter structure of two or more colors and having a black matrix or the like as necessary. Since the decorative material has the color filter layer, a decorative material which has further designability and can be visible only in a specific wavelength range is obtained.

From the viewpoint of visibility, the total light transmittance of the colored layer for viewing through at least one layer of the colored layer, preferably through the liquid crystal layer, is preferably 10% or less.

The color of the colored layer is not limited, and can be appropriately selected depending on the application of the decorative material, and the like. Examples of the color of the colored layer include black, gray, white, red, orange, yellow, green, blue, and violet. In addition, the color of the colored layer may be a metallic color.

From the viewpoint of strength and scratch resistance, the colored layer preferably includes a resin. Examples of the resin include a binder resin described later. In addition, the colored layer may be a layer formed by curing a polymerizable compound, or may be a layer including a polymerizable compound and a polymerization initiator. The polymerizable compound and polymerization initiator are not particularly limited, and a known polymerizable compound and polymerization initiator can be used.

Examples of the colorant include a pigment and a dye, and from the viewpoint of durability, a pigment is preferable. In order to make the colored layer metallic, metal particles, pearl pigments, and the like can be applied, and methods such as vapor deposition and plating can also be adopted.

The pigment is not limited, and a known inorganic pigment, organic pigment, and the like can be applied.

Examples of the inorganic pigment include white pigments such as titanium dioxide, zinc oxide, lithopone, light calcium carbonate, white carbon, aluminum oxide, aluminum hydroxide, and barium sulfate; black pigments such as carbon black, titanium black, titanium carbon, iron oxide, and graphite; iron oxide; barium yellow; cadmium red; and chrome yellow.

As the inorganic pigment, inorganic pigments described in paragraph 0015 and paragraph 0114 of JP2005-7765A can also be applied.

Examples of the organic pigment include phthalocyanine-based pigments such as phthalocyanine blue and phthalocyanine green; azo-based pigments such as azo red, azo yellow, and azo orange; quinacridone-based pigments such as quinacridone red, cinquasia red, and cinquasia magenta; perylene pigments such as perylene red and perylene maroon; carbazole violet; anthrapyridine; flavanthrone yellow; isoindoline yellow; indanthrone blue; dibromanzathrone red; anthraquinone red; and diketopyrrolopyrrole. Specific examples of the organic pigment include red pigments such as C. I. Pigment Red 177, 179, 224, 242, 254, 255, and 264; yellow pigments such as C. I. Pigment Yellow 138, 139, 150, 180, and 185; orange pigments such as C. I. Pigment Orange 36, 38, and 71; green pigments such as C. I. Pigment Green 7, 36, and 58; blue pigments such as C. I. Pigment Blue 15:6; and violet pigments such as C. I. Pigment Violet 23. As the organic pigment, organic pigments described in paragraph 0093 of JP2009-256572A can also be applied.

As the pigment, a pigment (so-called bright pigment) having a light-transmitting property and light-reflecting property may be included. Examples of the bright pigment include metallic bright pigments such as aluminum, copper, zinc, iron, nickel, tin, aluminum oxide, and alloys thereof, interference mica pigments, white mica pigments, graphite pigments, and glass flake pigments. The bright pigment may be uncolored or colored. In a case where exposure is performed in the molding of the decorative film for molding, the bright pigment is preferably used in a range which does not hinder the curing by exposure.

The colorant may be used alone or in combination of two or more kinds thereof. In addition, in a case where two or more kinds of colorants are used, the inorganic pigment and the organic pigment may be used in combination.

From the viewpoint of a target color development and molding process suitability, the content of the colorant is preferably 1% by mass to 50% by mass, more preferably 5% by mass to 50% by mass, and particularly preferably 10% by mass to 40% by mass with respect to the total mass of the colored layer.

From the viewpoint of improving dispersibility of the colorant included in the colored layer, particularly the pigment, the colored layer may contain a dispersant. By containing the dispersant, dispersibility of the colorant in the formed colored layer is improved, and the color of the decorative film to be obtained can be uniformized.

The dispersant can be appropriately selected and used according to the type, shape, and the like of the colorant, but is preferably a polymer dispersant.

Examples of the polymer dispersant include silicone polymers, acrylic polymers, and polyester polymers. In a case where it is desired to impart heat resistance to the decorative film, silicone polymers such as a graft type silicone polymer are preferably used as the dispersant.

A weight-average molecular weight of the dispersant is preferably 1,000 to 5,000,000, more preferably 2,000 to 3,000,000, and particularly preferably 2,500 to 3,000,000. In a case where the weight-average molecular weight is 1,000 or more, dispersibility of the colorant is further improved.

As the dispersant, a commercially available product may be used. Examples of the commercially available product include EFKA 4300 (acrylic polymer dispersant) manufactured by BASF Japan; HOMOGENOL L-18, HOMOGENOL L-95, and HOMOGENOL L-100 manufactured by Kao Corporation; Solsperse 20000 and Solsperse 24000 manufactured by Lubrizol Corporation; and DISPERBYK-110, DISPERBYK-164, DISPERBYK-180, and DISPERBYK-182 manufactured by BYK Chemie Japan. Note that, “HOMOGENOL”, “Solsperse”, and “DISPERBYK” are all registered trademarks.

The dispersant may be used alone or in combination of two or more kinds thereof.

A content of the dispersant is preferably 1 part by mass to 30 parts by mass with respect to 100 parts by mass of the colorant.

From the viewpoint of proper molding process, the colored layer preferably contains a binder resin. The binder resin is not limited, and a known resin can be applied. From the viewpoint of obtaining a desired color, as the binder resin, a transparent resin is preferable, and specifically, a resin having a total light transmittance of 80% or more is preferable. The total light transmittance can be measured with a spectrophotometer (for example, spectrophotometer UV-3100PC manufactured by Shimadzu Corporation).

Examples of the binder resin include acrylic resins, silicone resins, polyesters, polyurethanes, and polyolefins. The binder resin may be a homopolymer of a specific monomer or a copolymer of the specific monomer and another monomer.

The binder resin may be used alone or in combination of two or more kinds thereof.

From the viewpoint of moldability, the content of the binder resin is preferably 5% by mass to 70% by mass, more preferably 10% by mass to 60% by mass, and particularly preferably 20% by mass to 60% by mass with respect to the total mass of the colored layer.

The colored layer may contain an additive as necessary, in addition to the above-described components. The additive is not limited, and a known additive can be applied. Examples of the additive include surfactants described in paragraph 0017 of JP4502784B and paragraphs 0060 to 0071 of JP2009-237362A, thermal polymerization inhibitor described in paragraph 0018 of JP4502784B (also referred to as a polymerization inhibitor; preferred examples thereof include phenothiazine), and other additives described in paragraphs 0058 to 0071 of JP2000-310706.

A thickness of the colored layer is not particularly limited, but from the viewpoint of visibility and three-dimensional moldability, is preferably 0.5 μm or more, more preferably 3 m or more, still more preferably 3 μm to 50 μm, and particularly preferably 3 μm to 20 μm. In a case where the decorative material includes two or more colored layers, it is preferable that the colored layers each independently have a thickness within the above-described thickness range.

(Ultraviolet Absorbing Layer)

From the viewpoint of light resistance, the decorative material according to the embodiment of the present disclosure may include an ultraviolet absorbing layer. The ultraviolet absorbing layer is preferably a layer containing an ultraviolet absorber, and more preferably a layer containing an ultraviolet absorber and a binder polymer.

As the ultraviolet absorber, a known ultraviolet absorber can be used without particular limitation, and the ultraviolet absorber may be an organic compound or an inorganic compound. Examples of the ultraviolet absorber include triazine compounds, benzotriazole compounds, benzophenone compounds, salicylic acid compounds, and metal oxide particles. In addition, the ultraviolet absorber may be a polymer including an ultraviolet absorbing structure, and examples of the polymer including an ultraviolet absorbing structure include acrylic resins which include a monomer unit derived from an acrylic acid ester compound including at least a part of structures of a triazine compound, a benzotriazole compound, a benzophenone compound, a salicylic acid compound, and the like. Examples of the metal oxide particles include titanium oxide particles, zinc oxide particles, and cerium oxide particles.

Examples of the binder polymer include polyolefins, acrylic resins, polyesters, fluororesins, siloxane resins, and polyurethanes.

A thickness of the ultraviolet absorbing layer is not particularly limited, but from the viewpoint of light resistance and three-dimensional moldability, is preferably 0.01 μm 100 μm, more preferably 0.1 μm to 50 μm, and particularly preferably 0.5 μm to 20 μm.

(Reflection Band Central Wavelength)

In the decorative material according to the embodiment of the present disclosure, it is preferable that reflection band central wavelengths of visible light, which are measured in at least two regions, are different from each other. In a case where the reflection band central wavelengths of visible light, which are measured in at least two regions, are different from each other, lustrousness is high, and visibility rich in color change depending on the visual angle is obtained. The reflection band central wavelength is obtained by inverting a transmittance graph obtained using a spectrophotometer (for example, spectrophotometer UV-3100PC manufactured by Shimadzu Corporation), and based on a wavelength λ1 on a short wavelength side and a wavelength λ2 on a long wavelength side of two wavelengths which exhibit a reflectivity of 50% of the maximum reflectivity Rmax, calculating λs from an expression represented by λs=(λ1+λ2)/2. The reflection band central wavelength of visible light is adjusted, for example, by changing the pitch of the helical structure due to the isomerization of the photoisomerizable compound.

In the decorative material according to the embodiment of the present disclosure, an absolute value of a difference between a reflection band central wavelength of visible light, which is measured before a heating test at 80° C. for 240 hours, and a reflection band central wavelength of visible light, which is measured after the heating test at 80° C. for 240 hours, is preferably 0 nm to 20 nm, more preferably 0 nm to 15 nm, still more preferably 0 nm to 10 nm, and particularly preferably 0 nm to 5 nm. In a case where the above-described absolute value of the differences is small, the change in tint of the decorative material due to the migration of the low-molecular-weight compound is suppressed in the thermal environment. In the heating test, the sample is heated using an oven, and a measurement point after the heating test is the same as a measurement point before the heating test.

(Manufacturing Method of Decorative Material)

The manufacturing method of a decorative material is not limited as long as a desired decorative material is obtained. The decorative material is manufactured, for example, by combining the method for forming the pressure sensitive adhesive layer described in “Pressure sensitive adhesive layer” above and the method for forming the cholesteric liquid crystal layer described in “Cholesteric liquid crystal layer” above. It is preferable that the manufacturing method of a decorative material according to the embodiment of the present disclosure includes, in the following order: preparing a composition which contains a liquid crystal compound having a polymerizable group, a photoisomerizable chiral agent having a polymerizable group, and a photopolymerization initiator (hereinafter, referred to as “preparing step”); applying the composition onto a peelable base material (hereinafter, referred to as “applying step”); curing the composition with light to form a cholesteric liquid crystal layer (hereinafter, referred to as “curing step”); and forming a pressure sensitive adhesive layer on the cholesteric liquid crystal layer (hereinafter, referred to as “pressure sensitive adhesive layer forming step”).

In the preparing step, a composition which contains a liquid crystal compound having a polymerizable group, a photoisomerizable chiral agent having a polymerizable group, and a photopolymerization initiator is prepared. The composition is obtained, for example, by mixing raw materials by a known method. Aspects of each component in the composition are described in the section of “Cholesteric liquid crystal layer” above. As a preferred aspect of the composition, the aspect of the composition described in the section of “Cholesteric liquid crystal layer” above may be adopted.

In the preparing step, it is preferable that the photoisomerizable chiral agent includes a photoisomerizable chiral agent having two polymerizable groups. As described above, the photoisomerizable chiral agent having two polymerizable groups can induce the helical structure due to the liquid crystal compound, and also promote the curing reaction and reduce the content of the low-molecular-weight compound in the cholesteric liquid crystal layer.

In the preparing step, it is preferable that a proportion of the total amount of the compound having two polymerizable groups in the composition is 4% by mass to 25% by mass with respect to the total amount of solid contents of the composition. As described above, in a case where the above-described proportion is 4% by mass or more, the change in tint of the decorative material is suppressed in the thermal environment, and in a case where the above-described proportion is 25% by mass or less, the stretchability of the cholesteric liquid crystal layer is increased. Preferred ranges of the above-described proportion are described in the section of “Cholesteric liquid crystal layer” above.

In the applying step, the composition is applied onto a peelable base material. An aspect of the peelable base material is described in the section of “Peelable base material” above. Examples of the method of applying the composition include a roll coating method, a gravure printing method, a spin coating method, a wire bar coating method, an extrusion coating method, a direct gravure coating method, a reverse gravure coating method, and a die-coating method. In addition, the composition may be ejected from a nozzle using an ink jet device. The applying step preferably includes drying the composition applied onto the peelable base material. The composition may be dried, for example, by a known method. The composition may be dried by leaving. The composition may be dried by heating.

In the curing step, the composition is cured with light to form a cholesteric liquid crystal layer. In the curing step, an alignment state of the liquid crystal compound can be fixed. A light source used in the curing step may be determined depending on the type of the photopolymerization initiator. The light source is preferably a light source which radiates light including 365 nm, 405 nm, or 365 nm and 405 nm. Examples of the light source include an ultra-high pressure mercury lamp, a high pressure mercury lamp, and a metal halide lamp.

From the viewpoint of promoting the curing reaction, an illuminance is preferably 200 mW/cm² or more, more preferably 200 mW/cm² to 1,500 mW/cm², and still more preferably 300 mW/cm² to 1,000 mW/cm².

From the viewpoint of promoting the curing reaction, an irradiation amount if preferably 500 mJ/cm² or more, more preferably 500 mJ/cm² to 1,500 mJ/cm², and still more preferably 500 mJ/cm² to 1,000 mJ/cm².

As the exposure method, for example, methods described in paragraphs 0035 to 0051 of JP2006-23696A may be adopted.

In the curing step, the composition may be cured by a combination of light and heat, as well as light. From the viewpoint of promoting the curing reaction, a heating temperature is preferably 50° C. to 120° C., more preferably 60° C. to 120° C., and still more preferably 70° C. to 120° C. A heating time is preferably 1 minute to 2 hours. Examples of the heating unit include a heater, an oven, a hot plate, an infrared lamp, and an infrared laser.

The atmosphere in which the curing step is performed is not limited. The curing step may be performed in an atmosphere, in an oxygen atmosphere, or in a low oxygen atmosphere (preferably, in an atmosphere of an oxygen concentration of 1,000 ppm or less, that is, an atmosphere not including oxygen or including oxygen of more than 0 ppm and 1,000 ppm or less). In order to further promote the curing, the curing step is preferably performed in a low oxygen atmosphere, and more preferably performed under heating and in a low oxygen atmosphere.

In the pressure sensitive adhesive layer forming step, a pressure sensitive adhesive layer is formed on the cholesteric liquid crystal layer. A specific method for forming the pressure sensitive adhesive layer is described in the section of “Pressure sensitive adhesive layer” above.

It is preferable that the manufacturing method of the decorative material according to the embodiment of the present disclosure further includes, before the curing of the composition (that is, before the curing step), irradiating the composition with light through a photo mask, in which transmittances measured in at least two regions of the photo mask are different from each other. Hereinafter, the above-described method in this paragraph will be referred to as “photoisomerization step”.

In the photoisomerization step, for example, a range for isomerizing the photoisomerizable chiral agent and an isomerization proportion are adjusted according to an irradiation range of light and a wavelength of light reaching the composition. The irradiation range of light may be determined according to an object (for example, a shape of molding). In addition, light may be radiated through the photo mask such that a difference occurs between an isomerization proportion of a region and an isomerization proportion of another region. For example, in the composition, a region in which the isomerization proportion is 0% and a region in which the isomerization proportion is 100% may be formed. For example, in the composition, a region in which the isomerization proportion changes continuously or discontinuously from 0% to 100% may be formed. For example, in the composition, a region in which the isomerization proportion is 0% and a region in which the isomerization proportion changes continuously or discontinuously from 50% to 100% may be formed. For example, in the composition, a region in which the isomerization proportion is 10% and a region in which the isomerization proportion is 80% may be formed. The progress of photoisomerization can be known by measuring the maximum wavelength of reflectivity of the isomerized portion. The isomerization proportion represents a proportion of the number of photoisomerized photoisomerizable compound molecules to the total number of molecules of the target photoisomerizable compound, and similarly, the isomerization proportion can be determined by measuring the maximum wavelength of reflectivity.

In the photoisomerization step, an exposure intensity may be changed for each irradiation region of light. The exposure intensity can adjust the isomerization proportion. The exposure intensity may be changed continuously or discontinuously.

The light radiated to the composition in the photoisomerization step may be light having a wavelength capable of photoisomerization. Light having a wavelength range of 400 nm or less is preferable, light having a wavelength range of 360 nm or less is more preferable, and light having a wavelength range of 310 nm to 360 nm is still more preferable. A known unit and a known method can be used for adjusting the exposure wavelength in the photoisomerization step. Examples of the method include a method of using an optical filter, a method of using two or more types of optical filters, and a method of using a light source having a specific wavelength. In the photoisomerization step, it is preferable to perform the irradiation with light having a wavelength range in which no polymerization initiation species are generated from the polymerization initiator. For example, it is preferable to use a mask that transmits light having a wavelength range which causes the photoisomerization of the photoisomeric compound, and shields light having a wavelength range in which polymerization initiation species are generated from the polymerization initiator.

Examples of a light source used in the photoisomerization step include an ultra-high pressure mercury lamp, a high pressure mercury lamp, and a metal halide lamp. In addition, as the light source, a light emitting diode or the like capable of irradiating light having a narrow wavelength range can also be used. In this case, a mask may or may not be used as necessary.

An irradiation amount in the photoisomerization step is not particularly limited and may be set appropriately, but is preferably 5 mJ/cm² to 2,000 mJ/cm² and more preferably 10 mJ/cm² to 1,000 mJ/cm². In addition, the irradiation amount may be changed for each irradiation region according to the desired isomerization proportion.

In the photoisomerization step, it is preferable heat the composition. A heating temperature is not particularly limited and may be selected according to the photoisomerizable compound and the like to be used, and examples thereof include 60° C. to 120° C.

The exposure method in the photoisomerization step is not particularly limited as long as the photoisomerization occurs, and for example, methods described in paragraphs 0035 to 0051 of JP2006-23696A can be suitably used in the present disclosure.

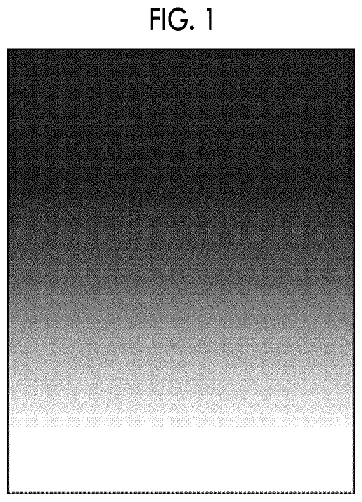

In the photoisomerization step, the transmittances measured in at least two regions of the photo mask are different from each other. For example, the photo mask may include a region in which the transmittance is 0% and a region in which the transmittance is 100%. For example, the photo mask may include a region in which the transmittance changes continuously or discontinuously from 0% to 100%. Examples of the photo mask including a region in which the transmittance changes continuously from 0% to 100% include a mask for patterning, shown in FIG. 1. Details of the mask for patterning, shown in FIG. 1, will be described later.

The manufacturing method of the decorative material according to the embodiment of the present disclosure may include, after the pressure sensitive adhesive layer forming step, introducing a base material having an uneven structure in place of the peelable base material. By peeling off the peelable base material from the laminate which is obtained through the preparing step and applying step described above, and the photoisomerization step, curing step, and pressure sensitive adhesive layer forming step as necessary, and then bonding the laminate including the pressure sensitive adhesive layer and the cholesteric liquid crystal layer with a base material having an uneven structure, the base material having an uneven structure is introduced in place of the peelable base material. An aspect of the base material having an uneven structure is described in the section of “Base material” above. The bonding between the laminate and the base material is preferably carried out under heating conditions. The heating temperature is preferably 50° C. to 90° C.

It is preferable that The manufacturing method of a decorative material according to another embodiment of the present disclosure includes preparing, by the above-described manufacturing method of a decorative material, a laminate which includes a pressure sensitive adhesive layer and a cholesteric liquid crystal layer in contact with the pressure sensitive adhesive layer, and bonding the laminate with a base material having an uneven structure. The laminate is obtained, for example, by the preparing step and applying step described above, and the photoisomerization step, curing step, and pressure sensitive adhesive layer forming step as necessary. In a case where the laminate includes the peelable base material, the base material having an uneven structure may be introduced into the laminate in place of the peelable base material by the above-described method. An aspect of the base material having an uneven structure is described in the section of “Base material” above. The bonding between the laminate and the base material is preferably carried out under heating conditions. The heating temperature is preferably 50° C. to 90° C.

<Decorative Panel>

The decorative panel according to the embodiment of the present disclosure includes a molded product of the decorative material according to the embodiment of the present disclosure. A preferred aspect of the decorative material is the same as the preferred aspect of the decorative material described in “Decorative material” above.

The molded product of the decorative material is produced, for example, by a known molding method. Examples of the molding method include insert molding and three-dimensional molding. In the insert molding, the molded product is obtained, for example, by disposing the decorative material in a mold and injection-molding a resin into the mold. By the insert molding, a molded product in which the resin molded product and the decorative material are integrated is obtained. Examples of the three-dimensional molding include heat molding, vacuum molding, pressure molding, and vacuum pressure molding. The vacuum refers to a state of 100 Pa or less. The vacuum molding is carried out using, for example, Formech 508FS manufactured by Nihon Seizuki Kogyo Co., Ltd. A temperature in the three-dimensional molding is preferably 60° C. or higher, more preferably 80° C. or higher, and still more preferably 100° C. or higher. The upper limit of the temperature in the three-dimensional molding is preferably 200° C.

The decorative panel is used, for example, in a housing of an electronic device and an interior and exterior of an automobile. However, the application of the decorative panel is not limited to the specific examples described above.

<Electronic Device>

The electronic device according to the embodiment of the present disclosure includes the decorative panel according to the embodiment of the present disclosure. A preferred aspect of the decorative panel is the same as the preferred aspect of the decorative panel described in “Decorative panel” above. Examples of the electronic device include a smartphone, a mobile phone, and a tablet.

### EXAMPLES

Hereinafter, the present disclosure will be described in detail with reference to examples, but the present disclosure is not limited thereto. In the following description, unless otherwise specified, “%” means “% by mass”, and “part” means “part by mass”.

<Support>

As a support, a polyethylene terephthalate film (manufactured by TOYOBO Co., Ltd., COSMOSHINE A4100, film thickness: 100 μm) including an easy-adhesive layer on one side was prepared. A rubbing treatment (rayon cloth, pressure: 0.1 kgf, rotation speed: 1,000 rpm (revolutions per minute), transportation speed: 10 m/min, number of times: 1 time) was carried out on one surface of the support, on which the easy-adhesive layer was not formed.

<Coating Liquid 1A for Forming Liquid Crystal Layer>

A coating liquid 1A for forming a liquid crystal layer, having the following composition, was prepared. In the following chemical formula, Me represents a methyl group.
Liquid crystal compound 1: 11.01 parts by mass

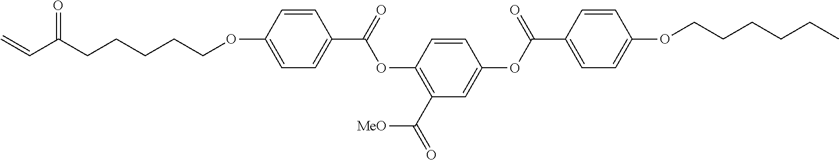 [SMILES: C=CC(=O)CCCCCOc1ccc(C(=O)Oc2ccc(OC(=O)c3ccc(OCCCCCC)cc3)cc2C(=O)OC)cc1]

Liquid crystal compound 2: 11.01 parts by mass

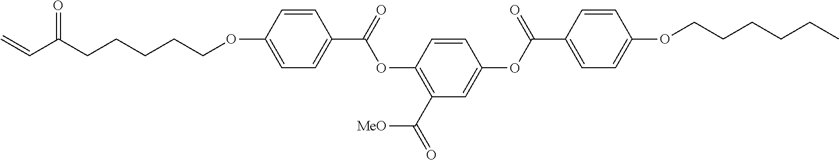 [SMILES: C=CC(=O)CCCCCOc1ccc(C(=O)Oc2ccc(OC(=O)c3ccc(OCCCCCC)cc3)cc2C(=O)OC)cc1]

Liquid crystal compound 3: 1.16 parts by mass

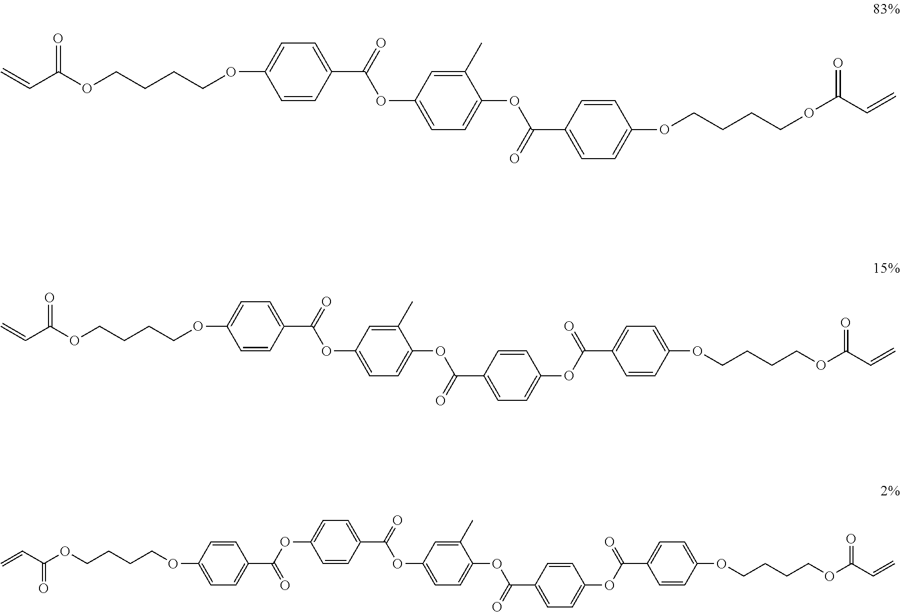

Chiral agent 1: 1.62 parts by mass

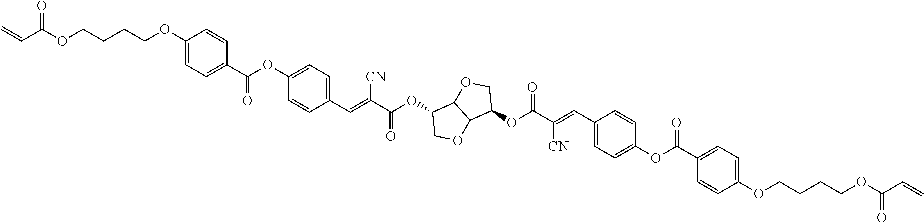 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccc(OCCCCOC(=O)C=C)cc4)cc3)cc2)cc1]

Photopolymerization initiator (diethylthioxanthone (manufactured by FUJIFILM Wako Pure Chemical Corporation)): 0.12 parts by mass
Surfactant 1: 0.07 parts by mass

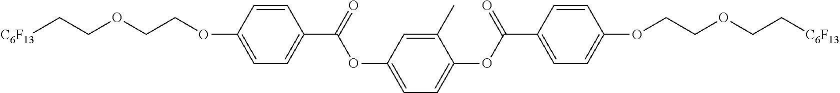

Surfactant 2: 0.01 parts by mass

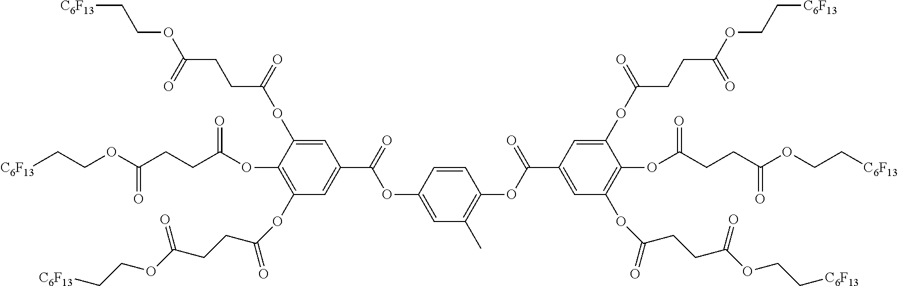

Methyl ethyl ketone (solvent): 52.5 parts by mass
Cyclohexanone (solvent): 22.5 parts by mass

<Coating Liquid 2A for Forming Liquid Crystal Layer>

A coating liquid 2A for forming a liquid crystal layer, having the following composition, was prepared.
Liquid crystal compound 4: 10.43 parts by mass

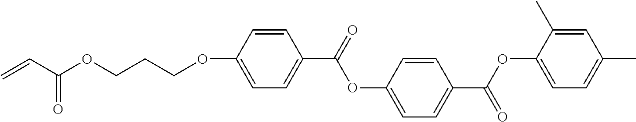 [SMILES: C=CC(=O)OCCCOc1ccc(C(=O)Oc2ccc(C(=O)Oc3ccc(C)cc3C)cc2)cc1]

Liquid crystal compound 5: 11.59 parts by mass

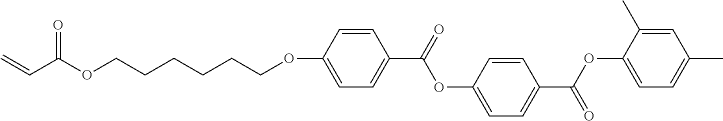 [SMILES: C=CC(=O)OCCCCCCOc1ccc(C(=O)Oc2ccc(C(=O)Oc3ccc(C)cc3C)cc2)cc1]

Liquid crystal compound 3: 1.16 parts by mass
Chiral agent 1: 1.62 parts by mass
Photopolymerization initiator (diethylthioxanthone (manufactured by FUJIFILM Wako Pure Chemical Corporation)): 0.12 parts by mass
Surfactant 1: 0.07 parts by mass
Surfactant 2: 0.01 parts by mass
Methyl ethyl ketone (solvent): 52.5 parts by mass
Cyclohexanone (solvent): 22.5 parts by mass

<Coating Liquid 3A for Forming Liquid Crystal Layer>

A coating liquid 3A for forming a liquid crystal layer, having the following composition, was prepared.
Liquid crystal compound 1: 11.81 parts by mass
Liquid crystal compound 2: 11.81 parts by mass
Chiral agent 1: 1.18 parts by mass
Photopolymerization initiator (diethylthioxanthone (manufactured by FUJIFILM Wako Pure Chemical Corporation)): 0.12 parts by mass
Surfactant 1: 0.08 parts by mass
Surfactant 2: 0.01 parts by mass
Methyl ethyl ketone (solvent): 52.5 parts by mass
Cyclohexanone (solvent): 22.5 parts by mass

<Coating Liquid 4A for Forming Liquid Crystal Layer>

A coating liquid 4A for forming a liquid crystal layer, having the following composition, was prepared.
Liquid crystal compound 1: 10.08 parts by mass
Liquid crystal compound 2: 10.08 parts by mass
Liquid crystal compound 3: 3.01 parts by mass
Chiral agent 1: 1.62 parts by mass
Photopolymerization initiator (diethylthioxanthone (manufactured by FUJIFILM Wako Pure Chemical Corporation)): 0.12 parts by mass
Surfactant 1: 0.07 parts by mass
Surfactant 2: 0.01 parts by mass
Methyl ethyl ketone (solvent): 52.5 parts by mass
Cyclohexanone (solvent): 22.5 parts by mass

<Coating Liquid 5A for Forming Liquid Crystal Layer>

A coating liquid 5A for forming a liquid crystal layer, having the following composition, was prepared.
Liquid crystal compound 1: 11.01 parts by mass
Liquid crystal compound 2: 11.01 parts by mass
Liquid crystal compound 3: 1.16 parts by mass
Chiral agent 2 (LC756 (manufactured by BASF)): 1.62 parts by mass
Photopolymerization initiator (diethylthioxanthone (manufactured by FUJIFILM Wako Pure Chemical Corporation)): 0.12 parts by mass
Surfactant 1: 0.07 parts by mass
Surfactant 2: 0.01 parts by mass
Methyl ethyl ketone (solvent): 52.5 parts by mass
Cyclohexanone (solvent): 22.5 parts by mass

<Coating Liquid 6A for Forming Liquid Crystal Layer>

A coating liquid 6A for forming a liquid crystal layer, having the following composition, was prepared.
Liquid crystal compound 1: 9.85 parts by mass
Liquid crystal compound 2: 9.85 parts by mass
Liquid crystal compound 3: 3.48 parts by mass
Chiral agent 1: 1.62 parts by mass
Photopolymerization initiator (diethylthioxanthone (manufactured by FUJIFILM Wako Pure Chemical Corporation)): 0.12 parts by mass
Surfactant 1: 0.07 parts by mass
Surfactant 2: 0.01 parts by mass
Methyl ethyl ketone (solvent): 52.5 parts by mass
Cyclohexanone (solvent): 22.5 parts by mass

<Coating Liquid 1B for Forming Liquid Crystal Layer>

A coating liquid 1B for forming a liquid crystal layer, having the following composition, was prepared.
Liquid crystal compound 6 (LC242 (manufactured by BASF)): 13.7 parts by mass
Chiral agent 2: 0.48 parts by mass
Photopolymerization initiator (Omnirad 379EG (manufactured by IGM Resins B.V)): 0.4 parts by mass
Surfactant 3 (KH40 (manufactured by AGC SEIMI CHEMICAL CO., LTD.)): 0.03 parts by mass
Cyclopentanone (solvent): 85.5 parts by mass

<Coating Liquid 2B for Forming Liquid Crystal Layer>

A coating liquid 2B for forming a liquid crystal layer, having the following composition, was prepared.
Liquid crystal compound 3: 38.33 parts by mass
Chiral agent 2: 2.22 parts by mass
Photopolymerization initiator (Omnirad 819 (manufactured by IGM Resins B.V.)): 3.83 parts by mass
Surfactant 1: 0.03 parts by mass
Methoxyethyl acrylate: 55.59 parts by mass

<Coating Liquid 3B for Forming Liquid Crystal Layer>

A coating liquid 3B for forming a liquid crystal layer, having the following composition, was prepared.
Liquid crystal compound 7: 30.2 parts by mass

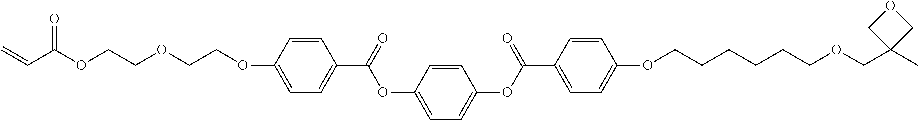 [SMILES: C=CC(=O)OCCOCCOc1ccc(C(=O)Oc2ccc(OC(=O)c3ccc(OCCCCCCOCC4(C)COC4)cc3)cc2)cc1]

Chiral agent 2: 2.04 parts by mass
Chiral agent 3: 0.23 parts by mass

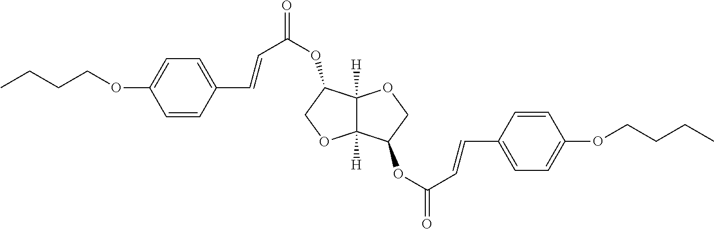 [SMILES: CCCCOc1ccc(/C=C/C(=O)O[C@H]2CO[C@H]3[C@@H]2OC[C@H]3OC(=O)/C=C/c2ccc(OCCCC)cc2)cc1]

Photopolymerization initiator (diethylthioxanthone (manufactured by FUJIFILM Wako Pure Chemical Corporation)): 0.91 parts by mass
Surfactant 1: 0.1 parts by mass
Methyl ethyl ketone (solvent): 53.3 parts by mass
Cyclohexanone (solvent): 13.3 parts by mass

<Coating Liquid 4B for Forming Liquid Crystal Layer>

A coating liquid 4B for forming a liquid crystal layer, having the following composition, was prepared.
Liquid crystal compound 1: 11.92 parts by mass
Liquid crystal compound 2: 11.92 parts by mass
Chiral agent 1: 0.95 parts by mass
Photopolymerization initiator (diethylthioxanthone (manufactured by FUJIFILM Wako Pure Chemical Corporation)): 0.12 parts by mass
Surfactant 1: 0.08 parts by mass
Surfactant 2: 0.01 parts by mass
Methyl ethyl ketone (solvent): 52.5 parts by mass
Cyclohexanone (solvent): 22.5 parts by mass

### Example 1

(Laminate 1A)

The coating liquid 1A for forming a liquid crystal layer was applied onto a rubbing-treated surface of the support with a wire bar #5, and dried at 85° C. for 2 minutes to form a liquid crystal layer.

Next, the liquid crystal layer was subjected to an isomerization treatment. Specifically, a mask for patterning, shown in FIG. 1, was closely attached to the support in the laminate including the support and the liquid crystal layer. By irradiating the liquid crystal layer with light of a metal halide lamp (MAL625NAL manufactured by GS Yuasa International Ltd.) through the mask, a part of the liquid crystal layer was subjected to the isomerization treatment. The mask for patterning, shown in FIG. 1, was produced using a black ink and polyethylene terephthalate as a base material. From one end to the other end of the mask, a transmittance of the mask changed continuously from 100% to 0%. The transmittance of the mask was adjusted with a dot density composed of dots of approximately 2 μm. As the dot density increases, the transmittance decreases. The dots were formed using the black ink. An irradiation amount of light was 10 mJ/cm².

Next, a curing treatment was performed on the liquid crystal layer to cure the liquid crystal layer. Specifically, the liquid crystal layer was irradiated with light of a metal halide lamp MAL625NAL manufactured by GS Yuasa International Ltd.) in a low oxygen atmosphere (an oxygen concentration of 1,000 ppm or less) on a hot plate at 85° C., thereby curing the liquid crystal layer. An irradiation amount of light was 1,000 mJ/cm². A reflection wavelength range of the cured liquid crystal layer was 450 nm to 650 nm.

Next, a pressure sensitive adhesive layer was formed on the cured liquid crystal layer using a pressure sensitive adhesive (G25 manufactured by NEION Film Coatings Corp.).

The laminate 1A obtained by the above-described procedure included the pressure sensitive adhesive layer, the cured liquid crystal layer (cholesteric liquid crystal layer), and the support in this order.

(Laminate 1B for Evaluation of Durability)

A PET base material (polyethylene terephthalate film, manufactured by TOYOBO Co., Ltd., COSMOSHINE A4360) was provided on the pressure sensitive adhesive layer in the laminate 1A. Next, glass (OA-10G manufactured by Nippon Electric Glass Co., Ltd.) was provided on the support in the laminate 1A through a pressure sensitive adhesive (G25 manufactured by NEION Film Coatings Corp.). The obtained laminate 1B included the PET base material, the pressure sensitive adhesive layer, the cured liquid crystal layer (cholesteric liquid crystal layer), the support, the pressure sensitive adhesive layer, and the glass in this order.

(Laminate 1C for Evaluation of Uneven Followability and Designability)

The support was peeled off from the cured liquid crystal layer in the laminate 1A to expose the cured liquid crystal layer. While heating at 80° C., a prism sheet having a 10 μm-high mountain-shaped uneven structure was attached to the cured liquid crystal layer. Next, a separator covering the pressure sensitive adhesive layer was peeled off, and glass (OA-10G manufactured by Nippon Electric Glass Co., Ltd.) was attached to the pressure sensitive adhesive layer. The obtained laminate 1C included the glass, the pressure sensitive adhesive layer, the cured liquid crystal layer (cholesteric liquid crystal layer), and the prism sheet in this order.

(Laminate 1D for Evaluation of Stretchability)

A coating liquid for an alignment layer, having the following composition, was prepared.
Modified polyvinyl alcohol (the numbers at the lower right of each constitutional unit represent the molar ratio): 10.00 parts by mass

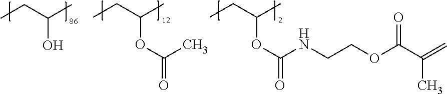

Water: 55.00 parts by mass
Methanol: 35.00 parts by mass

As a base material, TECHNOLLOY C000 (manufactured by Sumika Acryl Co., Ltd.) was prepared. A surface of the base material was subjected to a corona treatment under the conditions of 75 W, 0.5 m/min, and a distance between the base material and an electrode of 1 mm. The coating liquid for an alignment layer was applied onto the corona-treated surface of the base material with a wire bar #10, and dried at 85° C. for 2 minutes to form an alignment layer.

Next, the coating liquid 1 for forming a liquid crystal layer was applied onto the alignment layer with a wire bar #5 to form a liquid crystal layer.

Next, the liquid crystal layer was subjected to an isomerization treatment and a curing treatment according to the method described in “Laminate 1A” above. A reflection wavelength range of the cured liquid crystal layer was 450 nm to 650 nm.

### Example 2

Each laminate was obtained by the same procedure as in Example 1, except that the coating liquid 1A for forming a liquid crystal layer was changed to the coating liquid 2A for forming a liquid crystal layer. A reflection wavelength range of the cured liquid crystal layer was 450 nm to 650 nm.

### Example 3

Each laminate was obtained by the same procedure as in Example 1, except that the coating liquid 1A for forming a liquid crystal layer was changed to the coating liquid 3A for forming a liquid crystal layer. A reflection wavelength range of the cured liquid crystal layer was 600 nm to 800 nm.

### Example 4

Each laminate was obtained by the same procedure as in Example 1, except that the coating liquid 1A for forming a liquid crystal layer was changed to the coating liquid 4A for forming a liquid crystal layer. A reflection wavelength range of the cured liquid crystal layer was 450 nm to 650 nm.

### Example 5

Each laminate was obtained by the same procedure as in Example 1, except that the coating liquid 1A for forming a liquid crystal layer was changed to the coating liquid 5A for forming a liquid crystal layer. A reflection wavelength range of the cured liquid crystal layer was 450 nm.

### Example 6

Each laminate was obtained by the same procedure as in Example 1, except that the coating liquid 1A for forming a liquid crystal layer was changed to the coating liquid 6A for forming a liquid crystal layer. A reflection wavelength range of the cured liquid crystal layer was 450 nm to 650 nm.

### Comparative Example 1

Each laminate was obtained by the same procedure as in Example 1, except that the coating liquid 1A for forming a liquid crystal layer was changed to the coating liquid 1B for forming a liquid crystal layer. A reflection wavelength range of the cured liquid crystal layer was 630 nm.

### Comparative Example 2

Each laminate was obtained by the same procedure as in Example 1, except that the coating liquid 1A for forming a liquid crystal layer was changed to the coating liquid 2B for forming a liquid crystal layer. A reflection wavelength range of the cured liquid crystal layer was 550 nm.

### Comparative Example 3

Each laminate was obtained by the same procedure as in Example 1, except that the coating liquid 1A for forming a liquid crystal layer was changed to the coating liquid 3B for forming a liquid crystal layer. A reflection wavelength range of the cured liquid crystal layer was 450 nm to 550 nm.

### Comparative Example 4

Each laminate was obtained by the same procedure as in Example 1, except that the coating liquid 1A for forming a liquid crystal layer was changed to the coating liquid 4B for forming a liquid crystal layer. A reflection wavelength range of the cured liquid crystal layer was 750 nm to 950 nm.

<Evaluation>

The following evaluations were carried out using the respective laminates obtained in Examples and Comparative Examples. The laminate for evaluation of durability was used for durability, the laminate for evaluation of uneven followability and designability was used for uneven followability and designability, and the laminate for evaluation of stretchability was used for stretchability.

(Durability)

Using a spectrophotometer (manufactured by Shimadzu Corporation, spectrophotometer UV-3100PC; the same applies in this paragraph), a transmittance of a target laminate was measured. Next, the laminate was allowed to stand in an oven at 80° C. for 240 hours, and a transmittance of the laminate after the lapse of 240 hours was measured using the spectrophotometer. A difference Δλs between a reflection band central wavelength of visible light, calculated based on the transmittance measured before the heating, and a reflection band central wavelength of visible light, calculated based on the transmittance after the heating, was obtained. The reflection band central wavelength was obtained by inverting a transmittance graph obtained using the spectrophotometer, and based on a wavelength λ1 on a short wavelength side and a wavelength λ2 on a long wavelength side of two wavelengths which exhibited a reflectivity of 50% of the maximum reflectivity Rmax, calculating λs from an expression represented by λs=(λ1+λ2)/2. The durability was evaluated according to the following standard. As Δλs is smaller, the change in tint in a thermal environment is smaller. The evaluation results are shown in Table 1. A and B are acceptable levels.
A: Δλs≤10 nm
B: 10 nm≤Δλs<20 nm
C: 20 nm≤Δλs

(Uneven Followability)

The appearance of the target laminate was visually confirmed under white light, and the uneven followability was evaluated according to the following standard. The evaluation results are shown in Table 1. In a case where the cholesteric liquid crystal layer followed an uneven structure of the prism sheet, a sense of depth was generated in appearance.
A: there was a sense of depth in appearance.
B: there was a sense of depth in appearance, but some parts without a sense of depth were mixed.
C: there was no sense of depth in appearance.

(Designability)

The appearance of the target laminate was visually confirmed under white light. The designability was evaluated according to the following standard. The evaluation results are shown in Table 1.
A: tint was gradually changed along a direction orthogonal to a thickness direction of the laminate.
C: tint was not gradually changed along a direction orthogonal to a thickness direction of the laminate.

(Stretchability)

The target laminate was cut into a size of 1 cm×5 cm, and using a thermal tensilon (RTF-1310 and a constant temperature test device TKC manufactured by A&D Company), each 1 cm of upper and lower ends of the laminate was chucked, and a tensile test was performed at a speed of 300 mm/sec in an atmosphere of 150° C. to measure the maximum value which can be stretched without breaking (that is, a breaking elongation). The measurement results are shown in Table 1. In the evaluation of the stretchability, a base material (TECHNOLLOY C000) having high stretchability was used as a constituent element of the laminate, and the obtained breaking elongation was regarded as the breaking elongation of the cholesteric liquid crystal layer.

TABLE 1

| | Coating liquid for forming liquid | | | | | | | | | |
|---|---|---|---|---|---|---|---|---|---|---|
| | crystal layer (composition) | | | | | | | | | |
| | | | | [Bifunctional | | | | | | |
| | | | | compound]/ | Cholesteric liquid crystal layer | | | | | |
| | | Chiral agent | | [solid | | Content of | Evaluation | | | |
| | | Isomer- | Polymer- | content of | Reflected | low-molecular- | Stretchability | Uneven | | |
| | | ization | izable | composition] | wavelength | weight compound | (breaking | follow- | Durability | Design- |
| | Type | structure | group | (% by mass) | range (nm) | (mg/cm³) | elongation) | ability | (Δλs) | ability |
| Comparative | 1B | N | Y | 97.8 | 630 | 159 | <5% | C | C | C |
| Example 1 | | | | | | | | | (60 nm) | |
| Comparative | 2B | N | Y | 40.6 | 550 | 106 | <5% | C | C | C |
| Example 2 | | | | | | | | | (30 nm) | |
| Comparative | 3B | Y | Y/N | 6.12 | 450 to 550 | 172 | 28% | A | C | A |
| Example 3 | | | | | | | | | (65 nm) | |
| Comparative | 4B | Y | Y | 3.8 | 750 to 950 | 50 | 35% | A | C | A |
| Example 4 | | | | | | | | | (21 nm) | |
| Example 1 | 1A | Y | Y | 11.12 | 450 to 650 | 12.5 | 25% | A | A | A |
| | | | | | | | | | (3 nm) | |
| Example 2 | 2A | Y | Y | 11.12 | 450 to 650 | 12.5 | 25% | A | A | A |
| | | | | | | | | | (3 nm) | |
| Example 3 | 3A | Y | Y | 4.72 | 600 to 800 | 34.3 | 30% | A | A | A |
| | | | | | | | | | (9 nm) | |
| Example 4 | 4A | Y | Y | 18.52 | 450 to 650 | 4.7 | 20% | A | A | A |
| | | | | | | | | | (1 nm) | |
| Example 5 | 5A | Y | Y | 11.12 | 450 | 9.4 | 25% | A | A | C |
| | | | | | | | | | (3 nm) | |
| Example 6 | 6A | Y | Y | 20.4 | 450 to 550 | 3.1 | 15% | B | A | A |
| | | | | | | | | | (3 nm) | |

The following terms described in Table 1 have the following meanings, respectively.
“[Bifunctional compound]/[solid content of composition]”: in the composition, a proportion of the total amount of the compound having two polymerizable groups with respect to the total amount of solid contents of the composition
“Content of low-molecular-weight compound”: content of the compound having a molecular weight of 10,000 or less per unit volume of the cholesteric liquid crystal layer

Table 1 shows that, in Examples 1 to 6, the change in tint in a thermal environment was smaller than that in Comparative Examples 1 to 4.

The disclosure of Japanese Patent Application No. 2021-045075 filed on Mar. 18, 2021 is incorporated in the present specification by reference.

All documents, patent applications, and technical standards described in the present specification are incorporated herein by reference to the same extent as in a case of being specifically and individually noted that individual documents, patent applications, and technical standards are incorporated by reference.

What is claimed is:

1. A decorative material comprising:
a pressure sensitive adhesive layer; and
a cholesteric liquid crystal layer in contact with the pressure sensitive adhesive layer,
wherein, in the cholesteric liquid crystal layer, a content of a compound having a molecular weight of 10,000 or less per unit volume of the cholesteric liquid crystal layer is less than 44 mg/cm³.

2. The decorative material according to claim 1,
wherein a breaking elongation of the cholesteric liquid crystal layer is 20% or more.

3. The decorative material according to claim 1, further comprising:
a peelable base material,
wherein the decorative material has a structure in which the peelable base material, the cholesteric liquid crystal layer, and the pressure sensitive adhesive layer are arranged in this order.

4. The decorative material according to claim 1, further comprising:
a base material.

5. The decorative material according to claim 4,
wherein the base material has an uneven structure.

6. The decorative material according to claim 1,
wherein reflection band central wavelengths of visible light, which are measured in at least two regions, are different from each other.

7. The decorative material according to claim 1,
wherein an absolute value of a difference between a reflection band central wavelength of visible light, which is measured before a heating test at 80° C. for 240 hours, and a reflection band central wavelength of visible light, which is measured after the heating test at 80° C. for 240 hours, is 0 nm to 20 nm.

8. A decorative panel comprising:
a molded product of the decorative material according to claim 1.

9. An electronic device comprising:
the decorative panel according to claim 8.

10. A manufacturing method of a decorative material, comprising, in the following order:
preparing a composition which contains a liquid crystal compound having a polymerizable group, a photoisomerizable chiral agent having a polymerizable group, and a photopolymerization initiator;
applying the composition onto a peelable base material;
curing the composition with light to form a cholesteric liquid crystal layer; and
forming a pressure sensitive adhesive layer on the cholesteric liquid crystal layer,
wherein the photoisomerizable chiral agent includes a photoisomerizable chiral agent having two polymerizable groups, and
a proportion of a total amount of a compound having two polymerizable groups in the composition is 4% by mass to 20% by mass with respect to a total amount of solid contents of the composition.

11. The manufacturing method of a decorative material according to claim 10,
wherein the photoisomerizable chiral agent is a compound represented by Formula (C1),

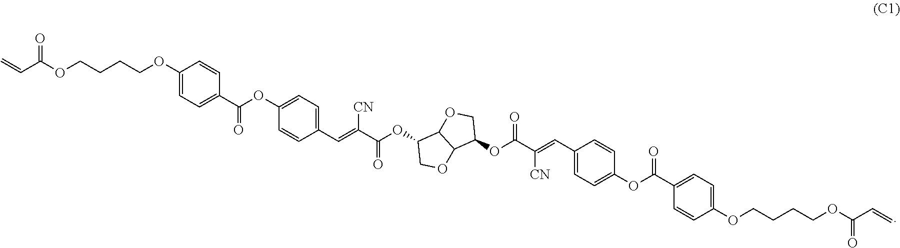 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccc(OCCCCOC(=O)C=C)cc4)cc3)cc2)cc1]

12. The manufacturing method of a decorative material according to claim 10, further comprising:
before the curing of the composition, irradiating the composition with light through a photo mask,
wherein transmittances measured in at least two regions of the photo mask are different from each other.

13. A manufacturing method of a decorative material, comprising:
preparing, by the manufacturing method of a decorative material according to claim 10, a laminate which includes a pressure sensitive adhesive layer and a cholesteric liquid crystal layer in contact with the pressure sensitive adhesive layer; and
bonding the laminate with a base material having an uneven structure.
